(19) United States
(12) Patent Application Publication
(10) Pub. No.: US 2015/0131548 A1
(43) Pub. Date: May 14, 2015

(54) RECEIVER, RECEIVING METHOD, AND PROGRAM

(71) Applicant: SONY CORPORATION, Minato-ku, Tokyo (JP)

(72) Inventors: Naohisa Kitazato, Tokyo (JP); Izumi Hatakeyama, Tokyo (JP); Masayuki Obayashi, Kanagawa (JP)

(73) Assignee: SONY CORPORATION, Minato-ku, Tokyo (JP)

(21) Appl. No.: 14/397,937

(22) PCT Filed: May 29, 2013
(86) PCT No.: PCT/JP2013/064856

§ 371 Date: Oct. 30, 2014

(30) Foreign Application Priority Data
Jun. 11, 2012 (JP) 2012-132277

(51) Int. Cl. H04H 40/18; H04W 72/00

(52) U.S. Cl. CPC H04H 40/18; H04W 72/005
USPC 370/329

(57) ABSTRACT

The present technology relates to a receiver, a receiving method, and a program capable of rapidly presenting receivable one segment broadcasting.

A station information obtaining unit obtains service area information used for selecting a service of broadcasting provided by a station which is included in stations transmitting broadcasting waves of the broadcasting at an arbitrary segment and transmits broadcasting waves receivable at a predetermined position. A station selecting unit selects a station transmitting broadcasting waves receivable at a predetermined position as a selectable station which is selectable based on the service area information. A channel selection control unit performs channel selection control for selecting the service of the broadcasting provided by the selectable station. The present technology is applicable to a portable receiving terminal for receiving one seg broadcasting, for example.

### TECHNICAL FIELD

The present technology relates to a receiver, a receiving method, and a program, and more particularly to a receiver, a receiving method, and a program capable of rapidly presenting receivable one segment broadcasting.

### BACKGROUND ART

In terrestrial digital broadcasting, a frequency band (hereinafter referred to as physical channels as well) of approximately 6 MHz in UHF (Ultra High Frequency) band is divided into 13 segments. Broadcasting for fixed terminals such as television receivers is provided by using 12 segments included in the 13 segments. Broadcasting for portable terminals, i.e., one segment broadcasting (hereinafter referred to as one seg broadcasting as well) is provided by using the remaining one segment.

One seg broadcasting currently provided as broadcasting for portable terminals includes the same contents as the contents of broadcasting for fixed terminals, and uses the central segment in the 13 segments of a physical channel (seventh segment in the ascending order of frequencies).

The one seg broadcasting currently provided at the central segment (hereinafter referred to as center segment as well) is called ordinary one seg broadcasting as well.

After complete transition from terrestrial analog broadcasting to terrestrial digital broadcasting, terrestrial digital broadcasting is provided at physical channels called 13 through 52 channels in UHF band.

However, all channels of 13 through 52 channels are not practically used for terrestrial digital broadcasting in respective areas. In this case, vacant channels corresponding to physical channels not used for terrestrial digital broadcasting are remaining.

Methods for utilizing these vacant channels are under consideration at present. One of the methods under consideration is utilization of an arbitrary segment included in the vacant channels for providing one seg broadcasting.

A physical channel of terrestrial digital broadcasting has 13 segments, wherefore 13 pieces of one seg broadcasting can be provided at the maximum by using one physical channel. Multiple one seg broadcasting using each of plural segments included in the 13 segments of one physical channel is called multi-segment broadcasting.

One seg broadcasting using each of arbitrary one or more segments included in 13 segments is called arbitrary one seg broadcasting as well. It is assumed that arbitrary one seg broadcasting includes multi-segment broadcasting.

When a user selects ordinary one seg broadcasting, a conventional receiving terminal (hereinafter referred to as ordinary one seg terminal as well) which receives ordinary one seg broadcasting performs channel scanning for obtaining channel selection information corresponding to information about channel selection such as frequencies, and creates a table of channel selection information (hereinafter referred to as channel selection table as well) (for example, see Patent Documents 1 and 2).

In channel scanning performed by ordinary one seg terminals, a center segment of each physical channel of terrestrial digital broadcasting is selected (tuned). When a TS (Transport Stream) is received at the center segment, both an NIT (Network Information Table) corresponding to a table containing frequency information determined for each service and used for tuning a carrier through which the service is transmitted, and information about the corresponding service, and an SDT (Service Description Table) corresponding to a table containing meta information about the corresponding service (such as service name) are extracted from the received TS. Then, a channel selection table is created based on the extracted NIT and SDT.

When a receiving terminal capable of receiving arbitrary one seg broadcasting is realized, a channel selection table for this receiving terminal similar to the channel selection table for the ordinary one seg terminal needs to be created.

However, arbitrary one seg broadcasting is provided using an arbitrary segment included in 13 segments of a physical channel. Simply speaking, not only the center segment of each physical channel but also all of the other segments of the 13 segments need to be selected in channel scanning. In this case, a considerable time is additionally required in comparison with the channel scanning performed by the ordinary one seg terminal.

Accordingly, a proposal of such a method has been demanded which performs channel scanning of arbitrary one seg broadcasting rapidly (in a short time).

### CITATION LIST

### Patent Document

Patent Document 1: JP 2006-325032 A

Patent Document 2: JP 2007-329847 A

### SUMMARY OF THE INVENTION

### Problems to be Solved by the Invention

There is proposed arbitrary one seg broadcasting (hereinafter referred to as area-limited broadcasting as well) provided for only a limited area in a range from several tens of meters to several kilometers around (an antenna of) a station corresponding to a transmitter for transmitting broadcasting waves of arbitrary one seg broadcasting, defining the limited area as a broadcasting area capable of receiving (broadcasting waves of) arbitrary one seg broadcasting.

Area-limited broadcasting is contained in a scope of arbitrary one seg broadcasting, wherefore a channel selection table needs to be created for a receiving terminal receiving area-limited broadcasting similarly to the case of reception of arbitrary one seg broadcasting. However, after a shift only in a range from several tens of meters to several kilometers, area-limited broadcasting, which has been previously receivable within a narrow broadcasting area, becomes unreceivable due to the narrow broadcasting area, while different new broadcasting becomes receivable. In this case, the selection channel table created prior to the shift may become unusable after the shift.

More specifically, assuming herein that broadcasting to be selected by a user through operation of a so-cal led channel button is referred to as a logic channel, there is a possibility that a receiving terminal for receiving area-limited broadcasting cannot receive a logic channel corresponding to area-limited broadcasting receivable prior to a shift of the user, when the user after the shift operates the channel button for selecting the corresponding logic channel presented to the user after the shift based on the channel selection table created prior to the shift.

Accordingly, channel scanning is again needed after the shift for presenting a receivable logic channel to the user after the shift.

However, a time is required to present a receivable logic channel to the user when channel scanning is required for every shift of the user.

The present technology developed in consideration of these circumstances allows rapid presentation of receivable one segment broadcasting.

### Solutions to Problems

A receiver or a program according to an aspect of the present technology is a receiver for receiving one segment broadcasting including, or a program for a computer having the functions of: an obtaining unit obtaining service area information used for selecting a service of the broadcasting provided by a station which is included in stations transmitting broadcasting waves of the broadcasting at an arbitrary segment and transmits broadcasting waves receivable at a predetermined position; a storing unit storing the service area information; a selecting unit selecting a station transmitting broadcasting waves receivable at a predetermined position as a selectable station which is selectable based on the service area information; and a channel selection control unit performing channel selection control for selecting the service of the broadcasting provided by the selectable station.

A receiving method according to an aspect of the present technology includes steps performed by a receiver, which steps includes: obtaining service area information used for selecting a service of broadcasting provided by a station which is included in stations transmitting broadcasting waves of the broadcasting at an arbitrary segment and transmits broadcasting waves receivable at a predetermined position; storing the service area information; selecting a station transmitting broadcasting waves receivable at a predetermined position as a selectable station which is selectable based on the service area information; and performing channel selection control for selecting the service of the broadcasting provided by the selectable station.

According to these aspects, the service area information used for selecting the service of the broadcasting provided by the station which is included in the stations transmitting broadcasting waves of the broadcasting at an arbitrary segment and transmits broadcasting waves receivable at a predetermined position is obtained. The service area information is stored. The station transmitting broadcasting waves receivable at a predetermined position is selected as a selectable station which is selectable based on the service area information. Channel selection control for selecting the service of the broadcasting provided by the selectable station is performed.

The receiver may be either an individual device, or an internal block constituting a device.

The program may be transmitted via a transmitting medium, or recorded in the form of a recording medium when provided.

### Effects of the Invention

According to an aspect of the present technology, rapid presentation of receivable one segment broadcasting is allowed.

### BRIEF DESCRIPTION OF DRAWINGS

FIG. 1 is a flowchart describing a channel selection table creating process.

FIG. 2 is a figure illustrating an example of a channel selection table.

FIG. 3 is a figure describing channel scanning performed by an ordinary one seg terminal.

FIG. 4 is a figure illustrating a constitution example of a transmitting and receiving system in an embodiment of the present technology.

FIG. 5 is a figure describing band allocation of terrestrial digital broadcasting.

FIG. 6 is a figure illustrating allocation of segments used for arbitrary one seg broadcasting.

FIG. 7 is a figure describing a method for obtaining channel selection information about area-limited broadcasting.

FIG. 8 is a figure describing NITs transmitted at a center segment of a physical channel for area-limited broadcasting.

FIG. 9 is a figure illustrating a constitution of NITs and SDTs at a center segment and segments other than the center.

FIG. 10 is a figure illustrating respective channel scanning performed by a receiving terminal 33 and an ordinary one seg terminal 100.

FIG. 11 is a figure illustrating an example of channel selection tables.

FIG. 12 is a figure illustrating broadcasting areas of ordinary one seg broadcasting, and a traffic line corresponding to a track of shift of a user carrying the ordinary one seg terminal 100 which only receives ordinary one seg broadcasting.

FIG. 13 is a figure illustrating broadcasting areas of area-limited broadcasting, and traffic lines corresponding to tracks of shift of a user carrying the receiving terminal 33 capable of receiving area-limited broadcasting.

FIG. 14 is a figure illustrating an example of station information.

FIG. 15 is a figure illustrating a method for specifying a signal format.

FIG. 16 is a figure illustrating an example of bit allocation in a signal format.

FIG. 17 is a figure illustrating an example of coding of directivity patterns.

FIG. 18 is a figure illustrating an example of a syntax of an NIT containing an area broadcasting descriptor.

FIG. 19 is a figure illustrating an example of a syntax of the area broadcasting descriptor.

FIG. 20 is a block diagram illustrating a detailed constitution example of a station 32.

FIG. 21 is a flowchart describing a transmitting process performed by the station 32.

FIG. 22 is a block diagram illustrating a detailed constitution example of the receiving terminal 33.

FIG. 23 is a figure describing obtainment and use of station information by the receiving terminal 33.

FIG. 24 is a block diagram illustrating a functional constitution example of a part of a control unit 80 performing channel selection control based on the station information.

FIG. 25 is a flowchart describing a process for obtaining the station information by channel scanning, and receiving a service.

FIG. 26 is a figure illustrating a display example of a display unit 76 at the time of obtainment of the station information by channel scanning and reception of the service.

FIG. 27 is a flowchart describing a process for obtaining the station information by direct system, and receiving a service.

FIG. 28 is a figure illustrating a display example of the display unit 76 at the time of obtainment of the station information by direct system and reception of the service.

FIG. 29 is a flowchart describing a process for obtaining the station information by other system.

FIG. 30 is a flowchart describing a channel selecting process in an individual selection mode.

FIG. 31 is a figure illustrating a display example of the display unit 76 when the channel selecting process in the individual selection mode is performed.

FIG. 32 is a flowchart describing a channel selecting process in a sequential selection mode.

FIG. 33 is a figure illustrating a display example of the display unit 76 when the channel selecting process in the sequential selection mode is performed.

FIG. 34 is a flowchart describing a channel selecting process in a map display mode.

FIG. 35 is a figure illustrating a display example of the display unit 76 when the channel selecting process in the map display mode is performed.

FIG. 36 is a flowchart describing a channel selecting process in a GPS mode.

FIG. 37 is a figure illustrating a display example of the display unit 76 when the channel selecting process in the GPS mode is performed.

FIG. 38 is a flowchart describing a selectable list registering process.

FIG. 39 is a flowchart describing a selectable list registering process.

FIG. 40 is a flowchart describing a checking process.

FIG. 41 is a figure illustrating an example of a notifying screen.

FIG. 42 is a figure illustrating a display example of the display unit 76 when the checking process is performed.

FIG. 43 is a block diagram showing a constitution example of hardware of a computer.

### MODE FOR CARRYING OUT THE INVENTION

An embodiment according to the present technology is hereinafter described with reference to the drawings.

### [Channel Scanning by Ordinary One Seg Terminal]

Discussed initially is channel scanning by an ordinary one seg terminal corresponding to a conventional receiving terminal for receiving ordinary one seg broadcasting.

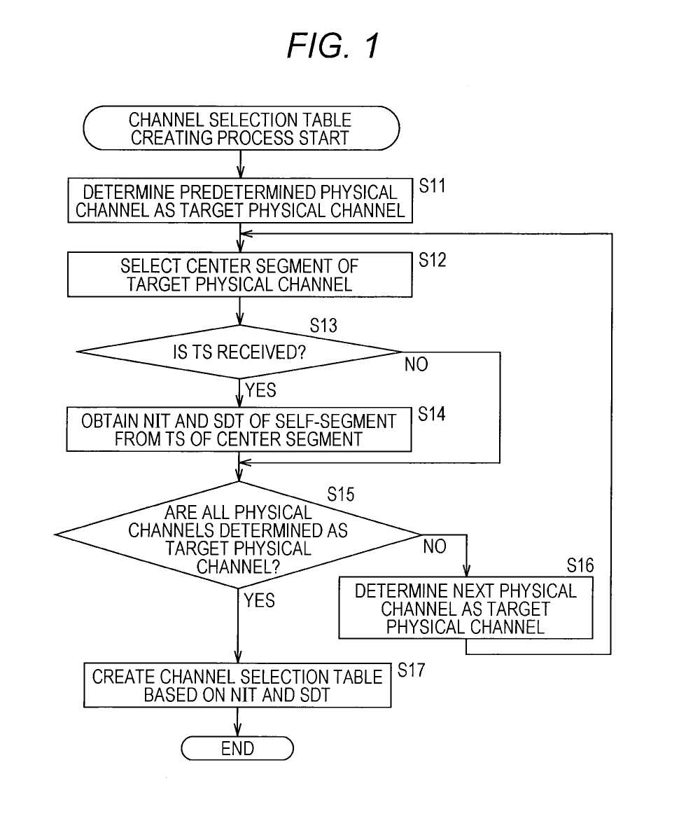

FIG. 1 is a flowchart describing channel scanning performed by the ordinary one seg terminal.

In step 11, the ordinary one seg terminal selects a physical channel having the lowest frequency, for example, as one physical channel included in physical channels in a range from 13 to 52 channels in UHF band, and determines the selected channel as a target physical channel corresponding to a processing target. Then, the process proceeds to step S12.

In step S12, the ordinary one seg terminal selects a center segment of the target physical channel. Then, the process proceeds to step S13.

In step S13, the ordinary one seg terminal determines whether or not a TS of the center segment of the target physical channel has been received. When it is determined that the TS has not been received, the process skips step S14 and proceeds to step S15.

When it is determined in step S13 that the TS of the center segment of the target physical channel has been received, the process proceeds to step S14. In this step, the ordinary one seg terminal obtains (extracts) an NIT (Network Information Table) of the self-segment (segment having received the TS) described as an NIT actual, and an SDT (Service Description Table) of the self-segment described as an SDT actual from the TS received at the center segment by the ordinary one seg terminal. Then, the process proceeds to step S15.

In step S15, the ordinary one seg terminal determines whether or not all the physical channels in the range from 13 to 52 channels in UHF band have been determined as target physical channels.

When it is determined in step S15 that there remains any physical channel not determined as a target physical channel, the process proceeds to step S16. In this step, the ordinary one seg terminal selects the physical channel having the second highest frequency next to the frequency of the current target physical channel, for example, and determines the physical channel having the second highest frequency as a new target physical channel. Then, the process returns to step S12.

On the other hand, when it is determined in step S15 that all the physical channels have been determined as target physical channels, the process proceeds to step S17. In this step, the ordinary one seg terminal creates a channel selection table based on the NIT and SDT obtained in step S14, and ends the channel scanning.

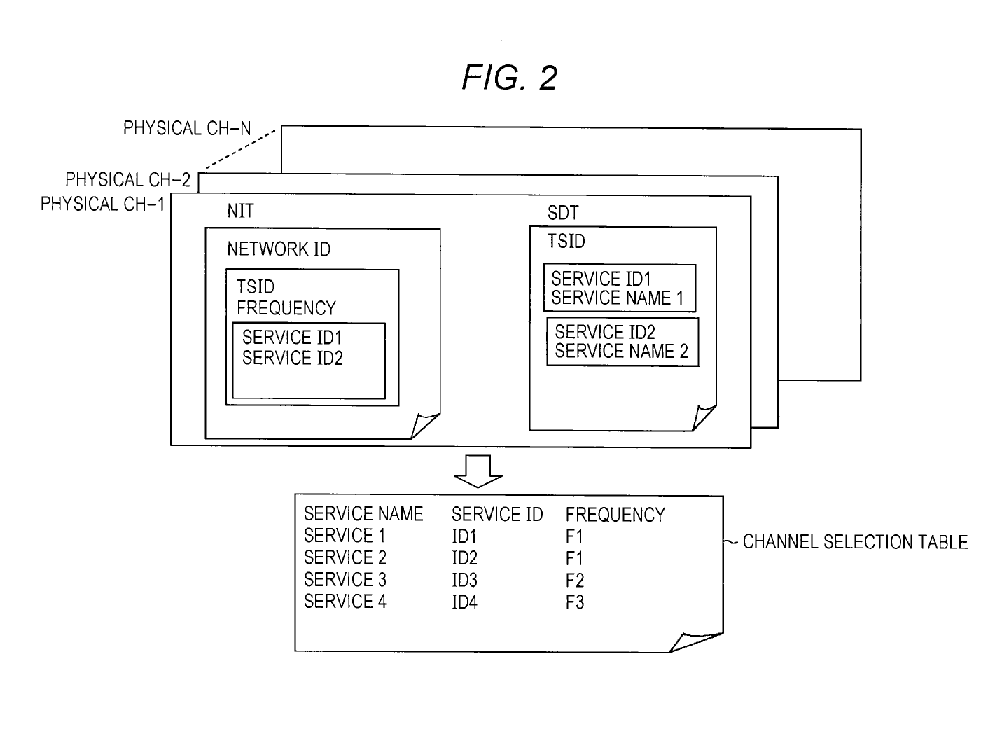

FIG. 2 is a figure illustrating a channel selection table created based on an NIT and an SDT.

The NIT describes a network ID as an ID peculiar to a corresponding network, a TSID as an ID peculiar to the TS, a frequency, a service ID as an ID peculiar to a corresponding (broadcasting) service, and others, in association with the self-segment. The SDT describes a TSID, a service ID, a service name corresponding to the service ID, and others, in association with the self-segment.

The ordinary one seg terminal obtains a service ID and a frequency for channel selection from the NIT of the center segment of each physical channel, and obtains a service name from the SDT corresponding to the NIT to associate the service name with the obtained service ID and the frequency. These service ID, service name, and frequency are registered in the channel selection table as channel selection information.

In FIG. 2, the center segment of a physical channel CH-1 having a frequency of F1 is used for two services having service IDs of ID1 and ID2. Accordingly, the NIT of the center segment of the physical channel CH-1 having the frequency of F1 describes both the service ID1 and the service ID2.

When a user carries out operation for selecting a service (logic channel) corresponding to a service name in the channel selection table presented as a name of a logic channel (such as “some TV” and “some channel” in a TV listing), for example, the ordinary one seg terminal selects the frequency associated with the service name in the channel selection table.

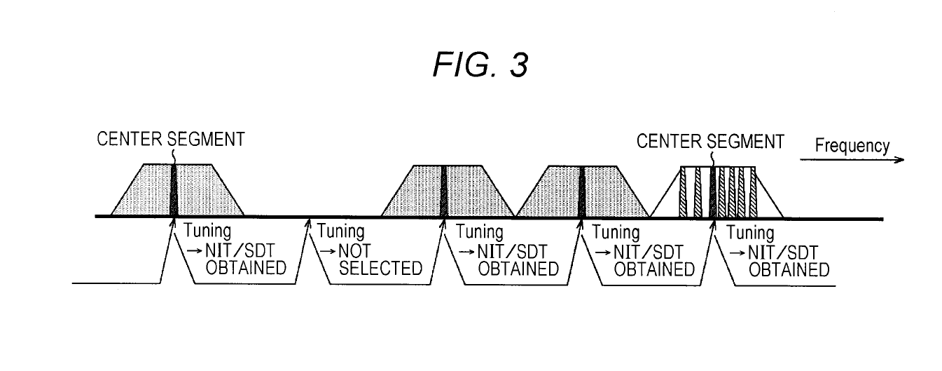

FIG. 3 is a figure describing channel scanning performed by the ordinary one seg terminal.

As discussed with reference to FIG. 1, the ordinary one seg terminal selects center segments of respective physical channels of terrestrial digital broadcasting in the ascending order of frequencies. When a TS is obtained in a center segment, the ordinary one seg terminal obtains an NIT and an SDT from the obtained TS.

Then, the ordinary one seg terminal creates a channel selection table based on the NIT and SDT obtained from the TS.

Accordingly, the ordinary one seg terminal can obtain channel selection information about arbitrary one seg broadcasting when the arbitrary one seg broadcasting is provided at a center segment. However, when the arbitrary one seg broadcasting is provided using segments other than a center segment (shaded areas in FIG. 3), the ordinary one seg terminal cannot obtain channel selection information about the arbitrary one seg broadcasting.

### [Constitution Example of Transmitting and Receiving System in Embodiment of Present Technology]

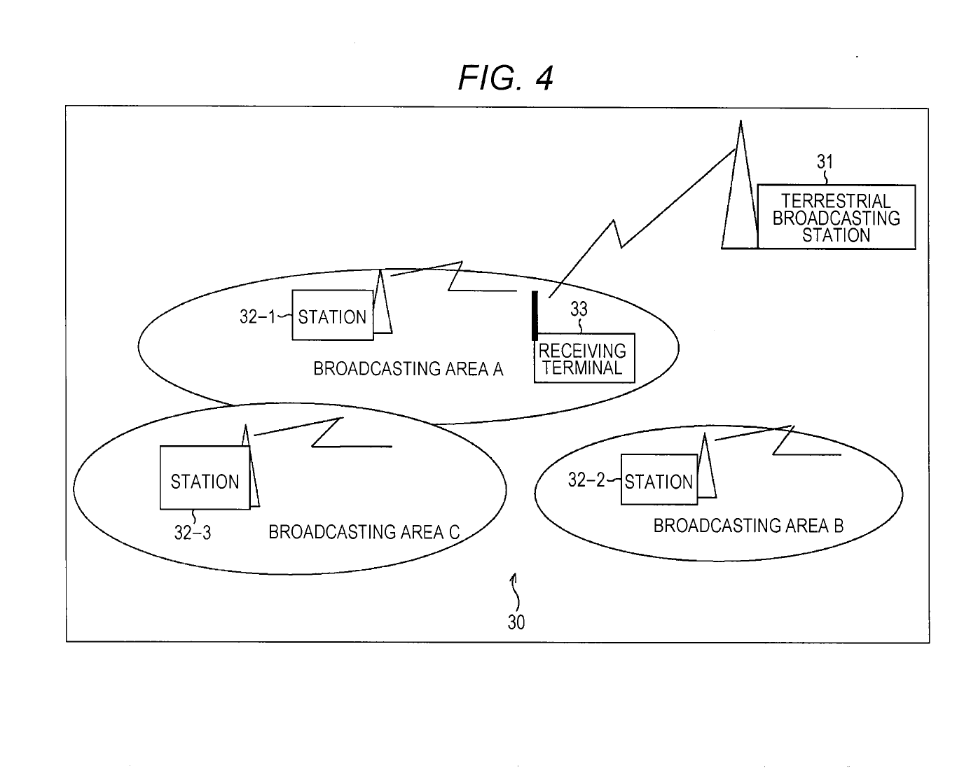

FIG. 4 illustrates a constitution example of a transmitting and receiving system according to an embodiment of the present technology.

In FIG. 4, a transmitting and receiving system 30 includes a terrestrial broadcasting station 31, stations 32-1, 32-2, and 32-3, and a receiving terminal 33.

The terrestrial broadcasting station 31 is a broadcasting station providing terrestrial digital broadcasting. The terrestrial broadcasting station 31 provides broadcasting for fixed terminals using 12 segments, and provides broadcasting for portable terminals (ordinary one seg broadcasting) using one segment.

The stations 32-1 through 32-3 are transmitters for transmitting broadcasting waves of arbitrary one seg broadcasting. Each of the stations 32-1 through 32-3 provides area-limited broadcasting corresponding to one seg broadcasting using one or more arbitrary segments of vacant channels of the terrestrial digital broadcasting.

More specifically, the station 32-1 provides area-limited broadcasting receivable only in a broadcasting area A.

The station 32-2 provides area-limited broadcasting receivable only in a broadcasting area B. The station 32-3 provides area-limited broadcasting receivable only in a broadcasting area C.

The stations 32-1 through 32-3 are collectively referred to as stations 32 when distinction between these stations is not particularly required.

The area-limited broadcasting includes broadcasting concerning a theme park and receivable only within the corresponding theme park, broadcasting concerning stores residing in a ward or a city and receivable only within the corresponding ward or city, for example.

According to area-limited broadcasting, stations whose broadcasting areas do not overlap with each other can provide broadcasting using the same segments.

More specifically, according to the example in FIG. 4, the broadcasting areas A and B do not overlap with each other. Thus, the station 32-1 in the broadcasting area A and the station 32-2 in the broadcasting area B can provide area-limited broadcasting using the same segments.

Moreover, the broadcasting areas B and C in FIG. 4 do not overlap with each other. Accordingly, the station 32-2 in the broadcasting area B and the station 32-3 in the broadcasting area C can provide area-limited broadcasting using the same segments.

However, the broadcasting areas A and C in FIG. 4 partially overlap with each other. In this case, the station 32-1 in the broadcasting area A and the station 32-3 in the broadcasting area C cannot use the same segments for providing respective area-limited broadcasting (as long as each broadcasting is simultaneously provided).

The receiving terminal 33 is a portable terminal capable of receiving both ordinary one seg broadcasting and area-limited broadcasting.

For example, when a user carrying the receiving terminal 33 is located within the broadcasting area A as illustrated in FIG. 4, the receiving terminal 33 can receive ordinary one seg broadcasting and area-limited broadcasting provided by the station 32-1 in the broadcasting area A.

The process performed by the receiving terminal 33 for receiving the ordinary one seg broadcasting is similar to the process performed by the conventional receiving terminal (ordinary one seg terminal) for receiving the ordinary one seg broadcasting. The explanation of the process is therefore omitted herein.

### [Explanation of Segment Used for Arbitrary One Seg Broadcasting]

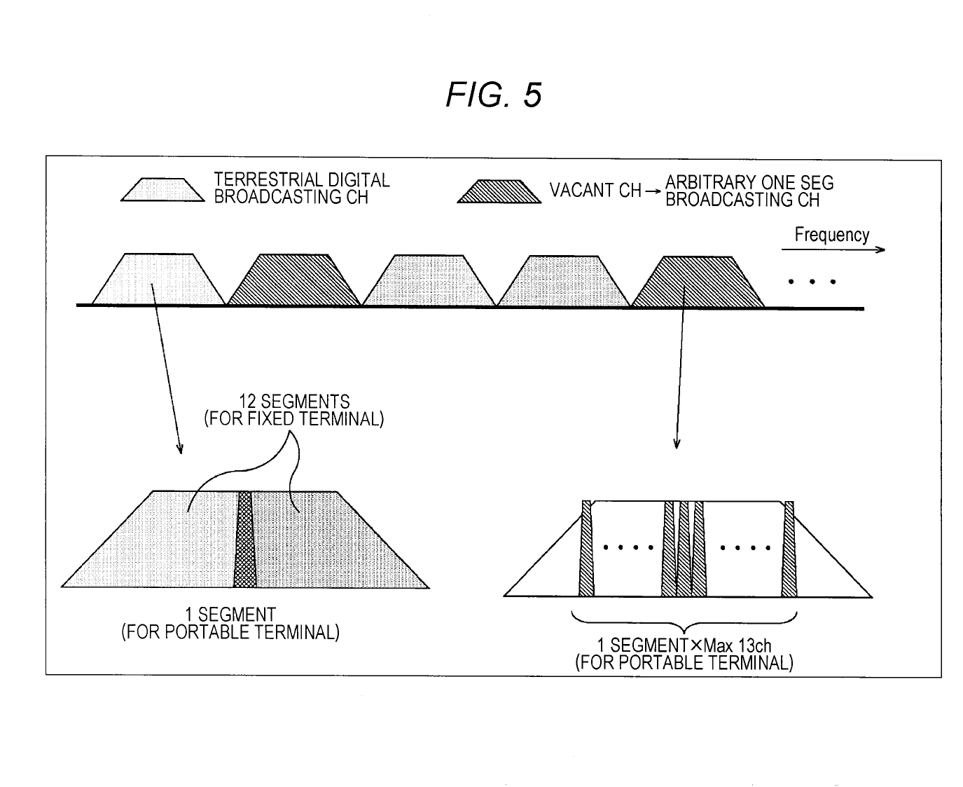

FIG. 5 is a figure describing band allocation of the terrestrial digital broadcasting according to the transmitting and receiving system 30 in FIG. 4.

According to the transmitting and receiving system 30, the ordinary one seg broadcasting is provided using a band of one segment positioned at the center in each physical channel included in all bands of terrestrial digital broadcasting and used for terrestrial digital broadcasting as illustrated in FIG. 5. In this case, broadcasting for fixed terminals is provided using bands of the remaining 12 segments.

As for the vacant channels, each of one or more segments can be used for area-limited broadcasting. The maximum number of the segments (logic channels) allowed to be used for area-limited broadcasting for one vacant cannel is 13 channels.

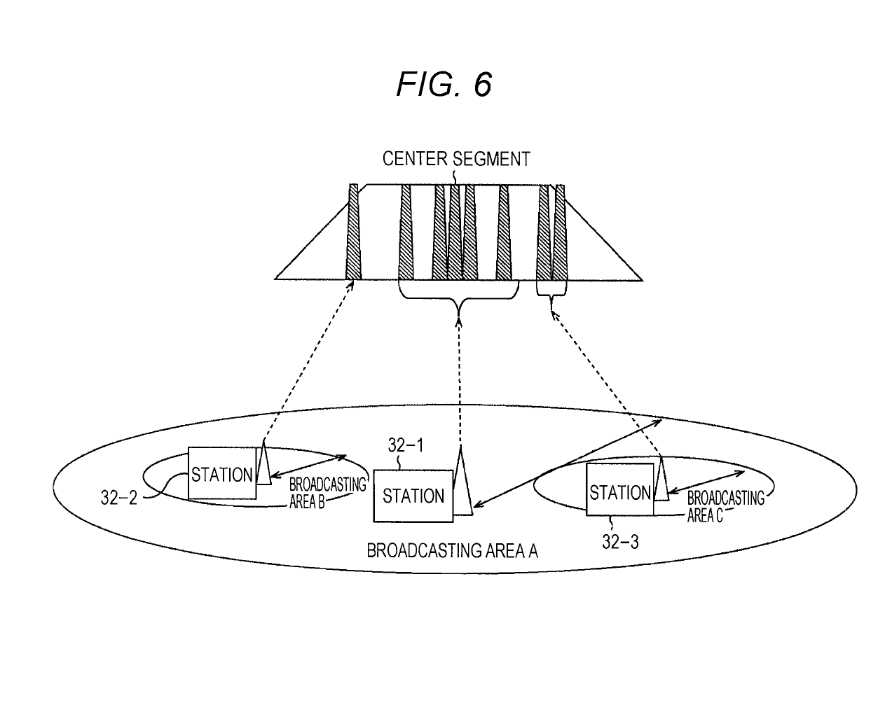

FIG. 6 is a figure illustrating an example of allocation of segments used for arbitrary one seg broadcasting.

An arbitrary segment of a vacant channel may be allocated to a segment used by each of the stations 32 for providing area-limited broadcasting corresponding to arbitrary one seg broadcasting. When a certain station retains other one or more stations under influence of the certain station, for example, a center segment may be allocated to the certain station.

More specifically, suppose that the station 32-1 is a central station having a predetermined district as the broadcasting area A, and that the stations 32-2 and 32-3 are local stations having buildings, amusement parks or the like within this district as the broadcasting areas B and C as illustrated in FIG. 6, for example. In this case, when the broadcasting area A includes the broadcasting areas B and C, one or more segments including a center segment of a predetermined vacant channel may be allocated to the station 32-1 as the central station, while segments included in this vacant channel and corresponding to segments other than the segment (s) allocated to the station 32-1 may be allocated to the stations 32-2 and 32-3 as the local stations.

### [Method for Obtaining Channel Selection Information]

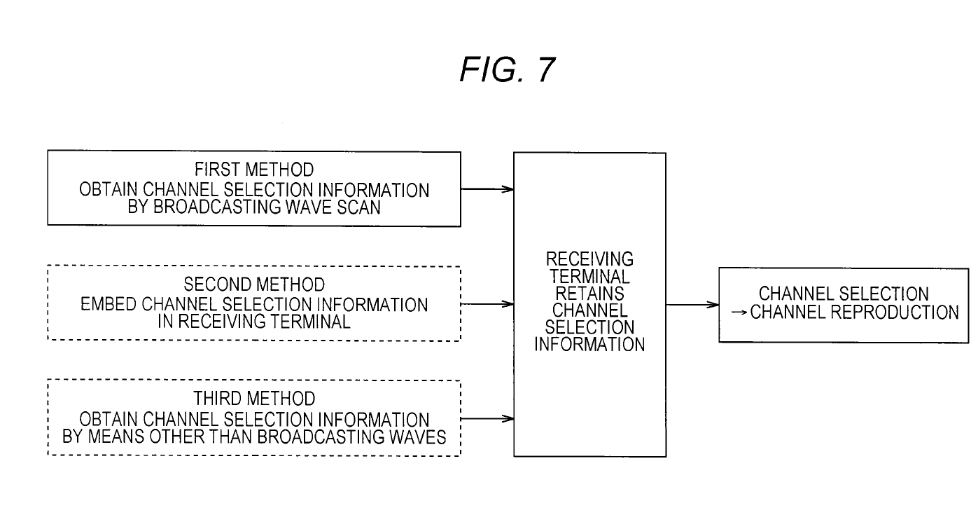

FIG. 7 is a figure describing a method for obtaining channel selection information about area-limited broadcasting.

As illustrated in FIG. 7, there are three types of first, second, and third methods as a method for obtaining channel selection information about area-limited broadcasting.

The first method is a method for obtaining channel selection information by channel scanning which scans broadcasting waves of terrestrial digital broadcasting.

According to the first method, the receiving terminal 33 selects respective segments of respective physical channels of terrestrial digital broadcasting, and obtains channel selection information about receivable area-limited broadcasting.

In the case of the first method, the user carrying the receiving terminal 33 need not recognize whether or not receivable area-limited broadcasting is present at the position of the user. In this case, the user can automatically obtain channel selection information about receivable area-limited broadcasting.

According to the first method, however, the user needs to select respective segments of respective physical channels of terrestrial digital broadcasting for every shift of the user. This method therefore requires a time for obtaining channel selection information about receivable area-limited broadcasting.

The second method is a method for embedding (storing beforehand) channel selection information in the receiving terminal 33.

According to the second method, channel selection information is stored in the receiving terminal 33 beforehand, wherefore the time for obtaining channel selection information is not needed.

However, the user carrying the receiving terminal 33 and executing operation for selecting a certain logic channel based on the channel selection information stored beforehand may not receive the corresponding logic channel (area-limited broadcasting) when the user is located out of the broadcasting area of the logic channel.

The third method is a method for obtaining channel selection information by using means other than broadcasting waves, i.e., through communication via the Internet, or communication with a contactless IC (Integrated Circuit) card, for example.

The third method allows more rapid obtainment of channel selection information in comparison with the first method.

However, in the case of the third method, there is a possibility that the user carrying the receiving terminal 33 and executing operation for selecting a certain logic channel cannot receive the corresponding logic channel, similarly to the second method.

As discussed above, the first method performing channel scanning for selecting respective segments of respective physical channels of terrestrial digital broadcasting requires a time for obtaining channel selection information in comparison with the other second and third methods.

Accordingly, described hereinafter is a method for allowing the receiving terminal 33 to obtain channel selection information more rapidly through channel scanning.

[Description of NIT and SDT Transmitted from Station 32]

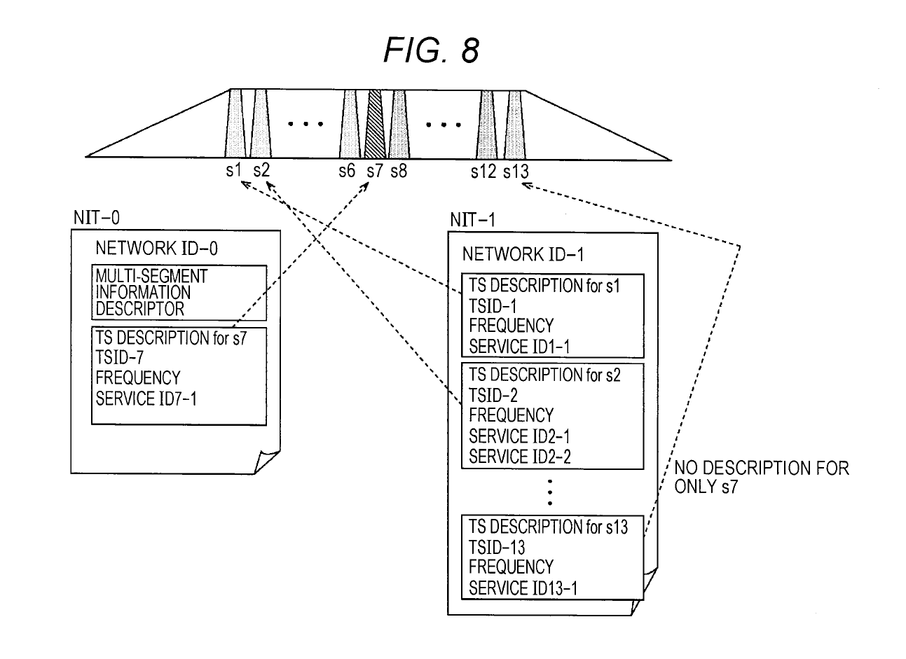

FIG. 8 is a figure describing NITs transmitted from the stations 32 shown in FIG. 4.

Assuming herein that area-limited broadcasting receivable in a certain broadcasting area is provided at each of 13 segments s1 through s13 constituting a certain physical channel, for example, the station 32 to which the center segment is allocated transmits following NIT-0 and NIT-1 at the center segment s7.

The NIT-0 is constituted by a network ID, a multi-segment information descriptor, and information about a TS of the center segment s7 (hereinafter referred to as TS information).

The multi-segment information descriptor is a descriptor indicating that arbitrary one seg broadcasting is provided at the segments of the physical channel containing the center segment s7.

The TS information of the center segment s7 contains a TSID of the TS of the center segment s7, a frequency of the center segment s7, a service ID of a broadcasting service of the center segment s7, and others.

The NIT-1 is constituted by a network ID, and TS information of the segments s1 through s6 and the segments s8 through s13 other than the center segment s7. The network ID of the NIT-0 is different from the network ID of the NIT-1. According to the example shown in FIG. 8, the network ID of the NIT-0 is 0, while the network ID of the NIT-1 is 1.

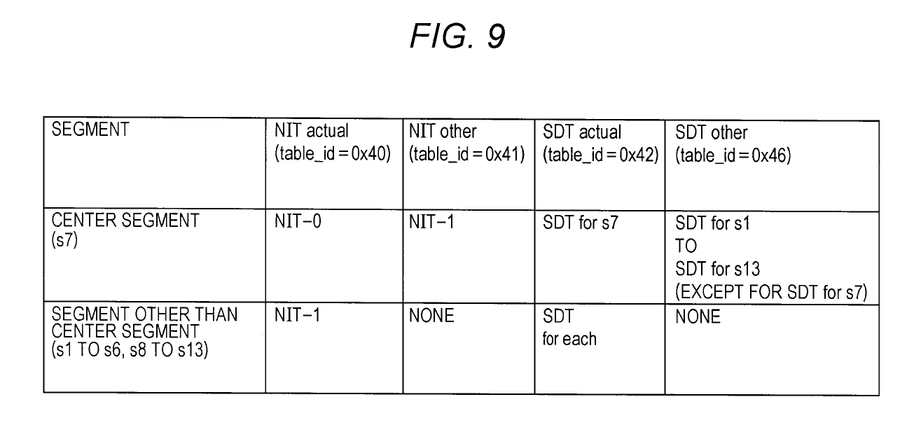

FIG. 9 is a figure describing the NIT and SDT transmitted at the respective segments.

As illustrated in FIG. 9, the NIT-0 is transmitted at the center segment s7 as an NIT actual for describing the NIT of the self-segment.

The NIT-1 is transmitted at the center segment s7 as an NIT other for describing the NIT of segments (hereinafter referred to as segments other than the center segment) which are included in the physical channel corresponding to the center segment s7 and agree with the segments other than the center segment s7 corresponding to the self-segment.

Moreover, the SDT of the center segment s7 is transmitted at the center segment s7 as an SDT actual for describing the SDT of the self-segment. In addition, the SDT of the segments other than the center segment s1 through s6 and s8 through s13 is transmitted at the center segment s7 as an SDT other for describing the SDT of the segments other than the center segment.

The NIT-1 is transmitted as an NIT actual at each of the segments other than the center segment s1 through s6 and s8 through s13, and nothing is transmitted as an NIT other thereat. In addition, the SDT of the self-segments s1 through s6 and s8 through s13 is transmitted as an SDT actual at each of the segments other than the center segment s1 through s6 and s8 through s13, and nothing is transmitted as an SDT other thereat.

As discussed above, in the case of transmission of NITs and SDTs, the receiving terminal 33 selects a center segment of each physical channel of terrestrial digital broadcasting in the ascending order of frequencies.

When the receiving terminal 33 receives a TS at a center segment, the receiving terminal 33 obtains an NIT and an SDT of area-limited broadcasting provided at the center segment based on an NIT actual and an SDT actual of the corresponding TS.

The receiving terminal 33 recognizes whether area-limited broadcasting corresponding to arbitrary one seg broadcasting is provided, or ordinary one seg broadcasting is provided based on the presence or absence of the multi-segment information descriptor in the NIT obtained from the NIT actual of the center segment.

When it is recognized that area-limited broadcasting is provided, the receiving terminal 33 obtains an NIT and an SDT of the area-limited broadcasting provided at the segments other than the center segment from an NIT other and an SDT other of the TS received at the center segment.

The receiving terminal 33 creates a channel selection table containing channel selection information about the area-limited broadcasting based on the NIT and SDT thus obtained.

As discussed with reference to FIGS. 8 and 9, the TS of the center segment contains not only the NIT actual and the SDT actual, but also the NIT other and the SDT other. Accordingly, the receiving terminal 33 can obtain NITs and SDTs of all area-limited broadcasting provided at each physical channel containing a center segment to be selected only by sequentially selecting center segments of respective physical channels.

Accordingly, the receiving terminal 33 can rapidly obtain channel selection information about area-limited broadcasting.

Transmission of an NIT other and an SDT other at a center segment is not necessarily required.

However, when an NIT other and an SDT other are not transmitted at a center segment, the receiving terminal 33 recognizes whether or not area-limited broadcasting is provided based on the presence or absence of a multi-segment information descriptor in an NIT actual at the center segment. When area-limited broadcasting is provided, the receiving terminal 33 needs to sequentially select segments other than the center segment to obtain an NIT actual and an SDT actual for each segment of the segments other than the center segment corresponding to each received TS.

An NIT actual contains information about a network to which the NIT actual is transmitted, while an NIT other contains information about a network different from a network to which the NIT other is transmitted. In addition, an SDT actual contains information about a network to which the SDT actual is transmitted, while an SDT other contains information about services of a network different from a network to which the SDT other is transmitted.

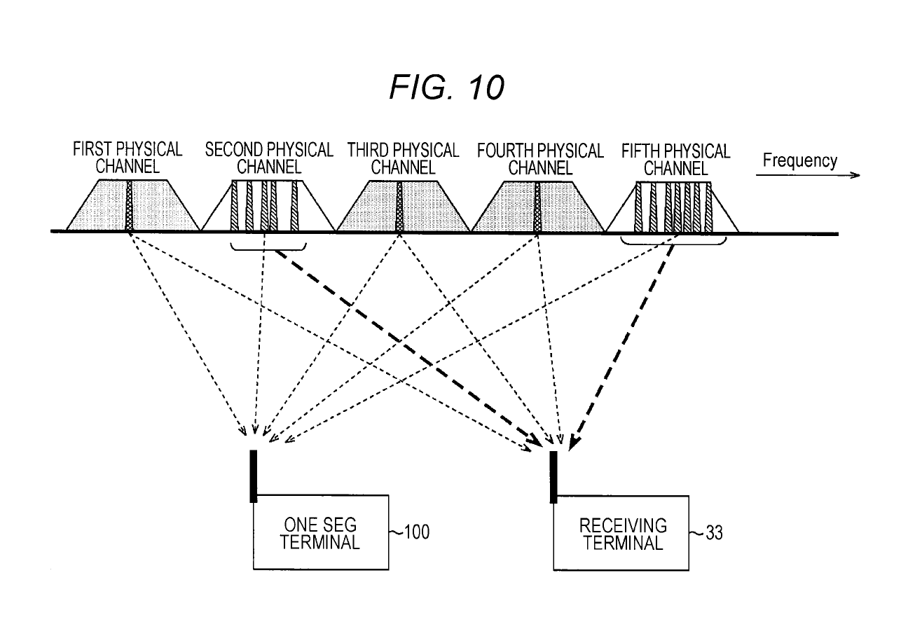

FIG. 10 is a figure illustrating channel scanning performed by the receiving terminal 33 shown in FIG. 4, and channel scanning performed by an ordinary one seg terminal 100 corresponding to a conventional receiving terminal for receiving ordinary one seg broadcasting.

Each of the receiving terminal 33 and the conventional ordinary one seg terminal 100 selects a center segment of each physical channel in the ascending order of frequencies, and obtains channel selection information to create a channel selection table.

The ordinary one seg terminal 100 does not deal with area-limited broadcasting (arbitrary one seg broadcasting), and thus ignores a multi-segment information descriptor of an NIT actual contained in a TS of a center segment of a physical channel to which the area-limited broadcasting is allocated. Accordingly, the ordinary one seg terminal 100 does not obtain an NIT other and an SDT other, while not causing malfunction.

As a result, the ordinary one seg terminal 100 obtains channel selection information based on NITs and SDTs at center segments of respective physical channels of ordinary one seg broadcasting and area-limited broadcasting as illustrated in FIG. 10.

On the other hand, the receiving terminal 33 deals with area-limited broadcasting. The receiving terminal 33 recognizes a multi-segment information descriptor of an NIT actual contained in a TS of a center segment of each physical channel to which area-limited broadcasting is allocated, and obtains an NIT other and an SDT other as well as the NIT actual and the SDT actual.

As a result, the receiving terminal 33 can obtain channel selection information based on all NITs and SDTs of the one seg broadcasting and the area-limited broadcasting allocated to respective physical channels.

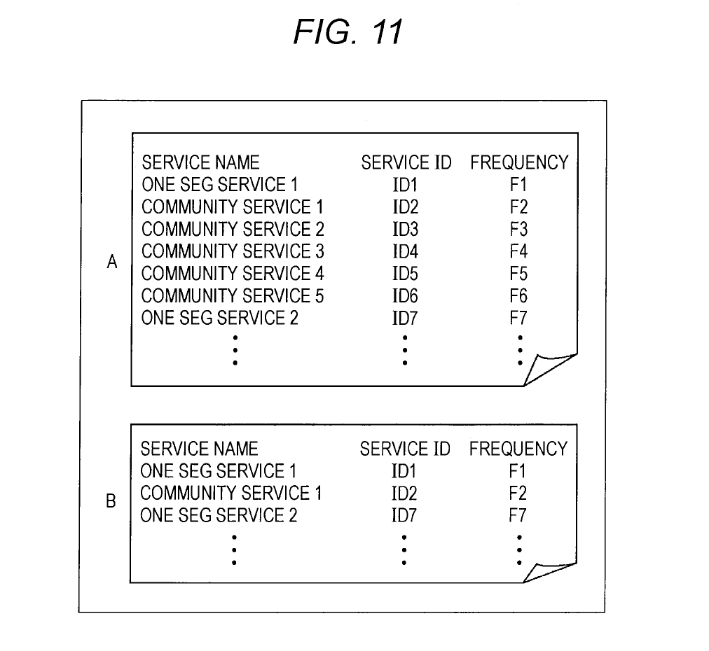

FIG. 11 is a figure illustrating an example of a cannel selection table created by the receiving terminal 33 according to the example in FIG. 10, and a channel selection table created by the ordinary one seg terminal.

A part A in FIG. 11 shows a channel selection table created by the receiving terminal 33.

Registered initially in the channel selection table created by the receiving terminal 33 are a service name “one seg service 1”, a service ID “ID1”, and a frequency “F1” of ordinary one seg broadcasting allocated to a center segment of a first physical channel shown in FIG. 10.

Registered next are service names “community service 1” through “community service 5”, service IDs “ID2” through “ID6”, and frequencies of “F2” through “F6” of area-limited broadcasting of five segments allocated to a second physical channel.

Registered subsequently are a service name “one seg service 2”, a service ID “ID7”, and a frequency “F7” of ordinary one seg broadcasting allocated to a center segment of a third physical channel.

Thereafter, service names, service IDs, and frequencies of ordinary one seg broadcasting allocated to a center segment of a fourth physical channel, and of area-limited broadcasting of seven segments allocated to a fifth physical channel are registered in a similar manner.

A part B in FIG. 11 illustrates a channel selection table created by the ordinary one seg terminal 100.

Registered initially in the channel selection table created by the ordinary one seg terminal 100 are the service name “one seg service 1”, the service ID “ID1”, and the frequency “F1” of the ordinary one seg broadcasting allocated to the center segment of the first physical channel similarly to the channel selection table created by the receiving terminal 33.

Registered next are the service name “community service 1”, the service ID “ID2”, and the frequency of “F2” of the area-limited broadcasting allocated to the center segment of the second physical channel.

Registered subsequently are the service name “one seg service 2”, the service ID “ID7”, and the frequency “F7” of the ordinary one seg broadcasting allocated to the center segment of the third physical channel similarly to the channel selection table created by the receiving terminal 33.

Thereafter, the service names, service IDs, and frequencies of the ordinary one seg broadcasting allocated to the center segment of the fourth physical channel, and of the area-limited broadcasting allocated to the center segment of the fifth physical channel are registered in a similar manner.

As discussed above, the conventional ordinary one seg terminal 100 cannot obtain channel selection information about area-limited broadcasting provided at segments other than the center segment, and thus does not register the information corresponding to the segments other than the center segment in the channel selection table. However, the conventional ordinary one seg terminal 100 can obtain channel selection information provided at the center segments, and thus registers the information corresponding to the center segments in the channel selection table.

Accordingly, as described with reference to FIGS. 8 and 9, transmission of NITs and SDTs does not interfere with reception of the ordinary one seg broadcasting by the conventional ordinary one seg terminal 100.

### [Broadcasting Area and Traffic Line of User]

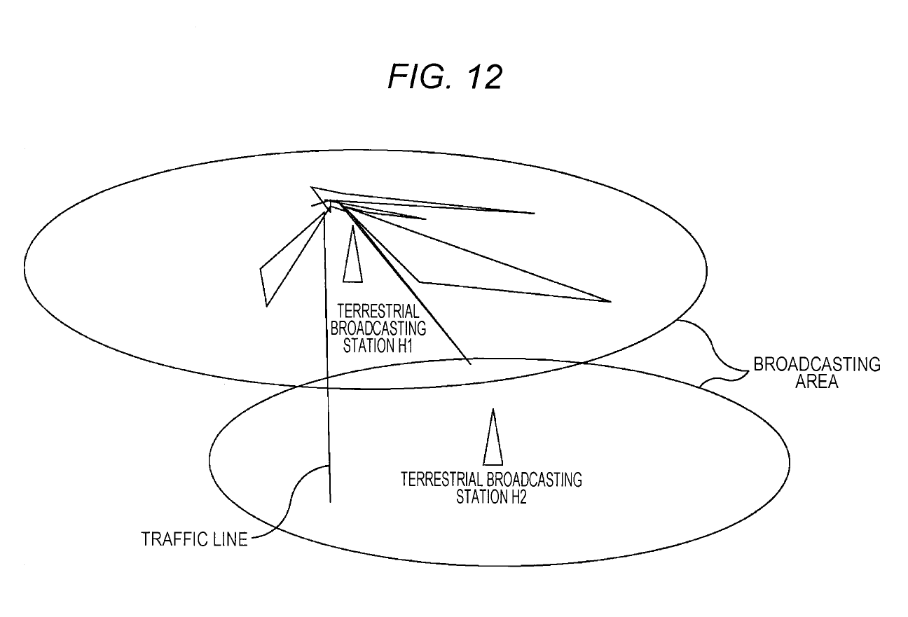

FIG. 12 is a figure illustrating broadcasting areas of terrestrial digital broadcasting (ordinary one seg broadcasting) and a traffic line corresponding to a track of shift of the user carrying the conventional ordinary one seg terminal 100 which receives only ordinary one seg broadcasting.

The broadcasting area of ordinary one seg broadcasting is wide, wherefore in daily life the user carrying the conventional ordinary one seg terminal 100 generally shifts within a broadcasting area of a particular terrestrial broadcasting station H1 as his/her sphere of everyday life. In this case, the user scarcely shifts from this broadcasting area into a broadcasting area of another terrestrial broadcasting station H2.

Accordingly, when the traffic lines of the user chiefly exist within the broadcasting area of the terrestrial broadcasting station H1 with a remaining only small part of the traffic lines of the user existing within the broadcasting area of the terrestrial broadcasting station H2 as illustrated in FIG. 12, the conventional one seg terminal 100 carried by the user registers the channel selection information about the ordinary one seg broadcasting provided by the terrestrial broadcasting station H1 in the channel selection table, and presents to the user (service names of) ordinary one seg broadcasting provided by the terrestrial broadcasting station H1 receivable in most cases as (service names of) ordinary one seg broadcasting selectable by the user.

According to the ordinary one seg terminal 100, ordinary one seg broadcasting provided by each of the terrestrial broadcasting stations H1 and H2 can be presented to the user as ordinary one seg broadcasting selectable by the user when channel selection information about ordinary one seg broadcasting provided by the terrestrial broadcasting station H2 as well as the channel selection information about the ordinary one seg broadcasting provided by the terrestrial broadcasting station H1 are registered in the channel selection table.

In this case, however, the ordinary one seg terminal 100 cannot receive the ordinary one seg broadcasting provided by the terrestrial broadcasting station H2 when the user carrying the ordinary one seg terminal 100 and existing in the broadcasting area of the terrestrial broadcasting station H1 selects the ordinary one seg broadcasting provided by the terrestrial broadcasting station H2.

Similarly, the ordinary one seg terminal 100 cannot receive the ordinary one seg broadcasting provided by the terrestrial broadcasting station H1 when the user carrying the ordinary one seg terminal 100 and existing in the broadcasting area of the terrestrial broadcasting station H2 selects the ordinary one seg broadcasting provided by the terrestrial broadcasting station H1.

According to the ordinary one seg terminal 100, it is needed to separately register the channel selection information about the ordinary one seg broadcasting provided by the terrestrial broadcasting station H1 from the channel selection information about the ordinary one seg broadcasting provided by the terrestrial broadcasting station H2, and urges the user to switch (carry out operation for switching) the selection tables used for channel selection as necessary so as to present only receivable ordinary one seg broadcasting to the user.

As discussed above, ordinary one seg broadcasting has a wide broadcasting area, wherefore in daily life the frequency of shifts of the user from the broadcasting area containing his/her sphere of everyday life into another broadcasting area is extremely low.

Accordingly, the probability of the necessity of switching the channel selection table used for channel selection is low, and the number of the channel selection tables requiring separate registration of channel selection information is small. Accordingly, switching the channel selection tables is easy.

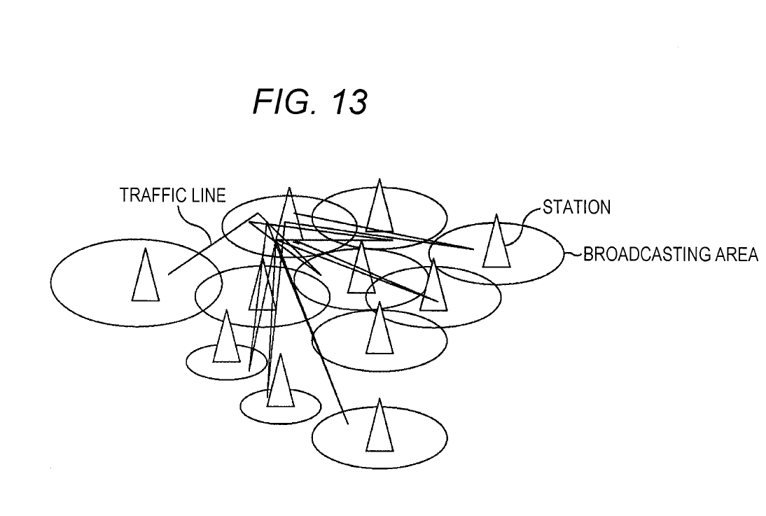

FIG. 13 is a figure illustrating broadcasting areas of area-limited broadcasting, and traffic lines corresponding to tracks of shift of the user carrying the receiving terminal 33 capable of receiving area-limited broadcasting.

Each of the broadcasting areas of area-limited broadcasting is narrow, wherefore a number of stations are provided within a not wide area with high density. In this case, it is assumed that the user carrying the receiving terminal 33 frequently shifts between the broadcasting areas of a number of the stations.

Accordingly, it is assumed that the area-limited broadcasting (logic channels) receivable by the receiving terminal 33 frequently varies during shifting of the user within his/her sphere of everyday life.

When the receiving terminal 33 separately registers a number of channel selection tables containing selection information about a number of pieces of area-limited broadcasting so as to present only receivable area-limited broadcasting to the user, and urges the user to switch the channel selection tables to be used for channel selection as necessary similarly to the ordinary one seg terminal 100 discussed with reference to FIG. 12, the user needs to switch a number of target channel selection tables to select the channel selection table to be used for channel selection. In addition, it is assumed that frequent switching is required.

Accordingly, it is not practical that the receiving terminal 33 separately registers a number of channel selection tables containing channel selection information about a number of pieces of area-limited broadcasting, and urges the user to switch the channel selection tables to be used for channel selection.

In addition, in the case of area-limited broadcasting provided in an event site or the like, it is assumed that the period for providing broadcasting and the broadcasting time zone are limited. In this case, there exists the occasion when area-limited broadcasting is receivable and the occasion when area-limited broadcasting is not receivable even within the broadcasting area of the corresponding station.

Accordingly, even when channel selection information about area-limited broadcasting is embedded in the receiving terminal 33 beforehand as limited and permanent information, the channel selection information about the area-limited broadcast the period of which for broadcasting has ended is useless. In addition, it is difficult to deal with area-limited broadcasting which will be started in the future.

On the other hand, even when the receiving terminal 33 obtains channel selection information about area-limited broadcasting receivable at the moment by performing channel scanning discussed with reference to FIG. 10, it is not necessarily secured in a later time that the receiving terminal 33 receives area-limited broadcasting in correspondence with the channel selection information obtained by the previous channel scanning after a shift of the user or after an elapse of time.

Accordingly, for presenting area-limited broadcasting receivable at the moment to the user as area-limited broadcasting selectable by the user at the position of the user, for example, it is needed to perform channel scanning constantly (or in a short cycle) for obtaining channel selection information about the receivable area-limited broadcasting.

However, the channel scanning discussed with reference to FIG. 10 requires a certain period of time, even while obtaining channel selection information relatively rapidly in comparison with the channel scanning for selecting respective segments of respective physical channels of terrestrial digital broadcasting.

Accordingly, execution of constant channel scanning is not practical.

For rapidly presenting receivable area-limited broadcasting to the user, the receiving terminal 33 receives station information concerning stations transmitting broadcasting waves of one segment broadcasting at arbitrary segment(s), and selects the stations 32 of the receivable area-limited broadcasting as selectable stations which are selectable by using the received station information.

### [Description of Station Information]

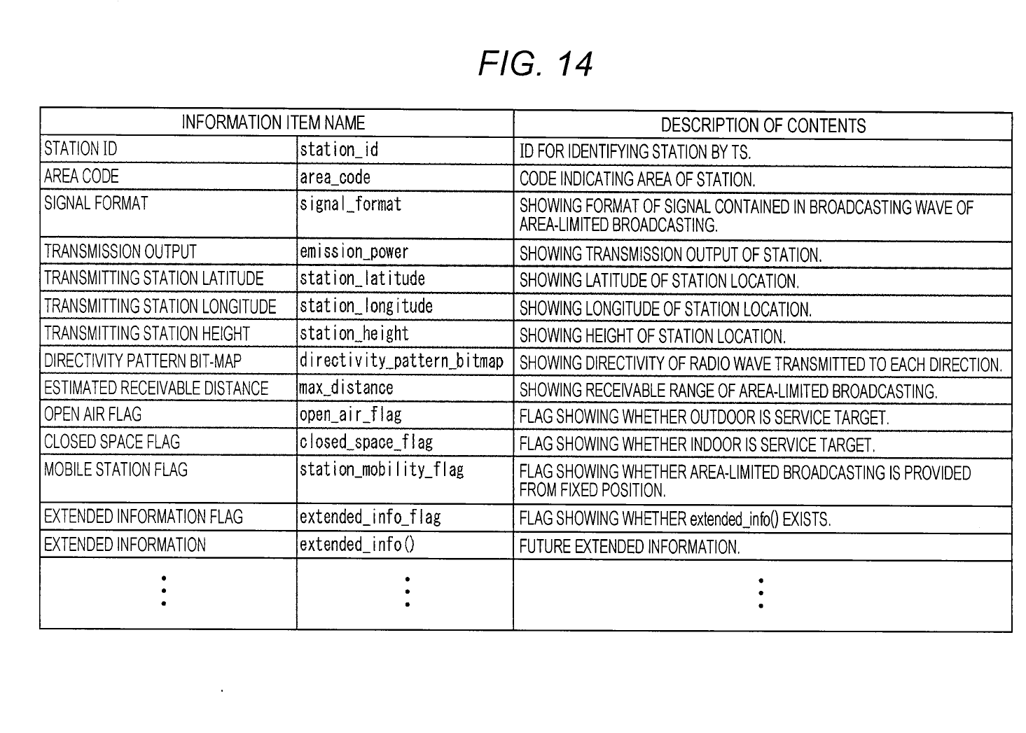

FIG. 14 is a figure describing station information.

The station information contains a station ID, an area code, a signal format, a transmission output, a transmitting station latitude, a transmitting station longitude, a transmitting station height, a directivity pattern bit-map, an estimated receivable distance, an open air flag, a closed space flag, a mobile station flag, an extended information flag, extended information, and others.

The station ID (station_id) is a unique ID for identifying the stations 32 by units of TS (units of segment). The receiving terminal 33 retains and manages station information based on the station IDs.

The area code (area_code) is an ID for identifying locations of the stations 32 identified by the station IDs. For example, municipality codes of the locations of the stations 32 identified by the station IDs may be used for the area codes.

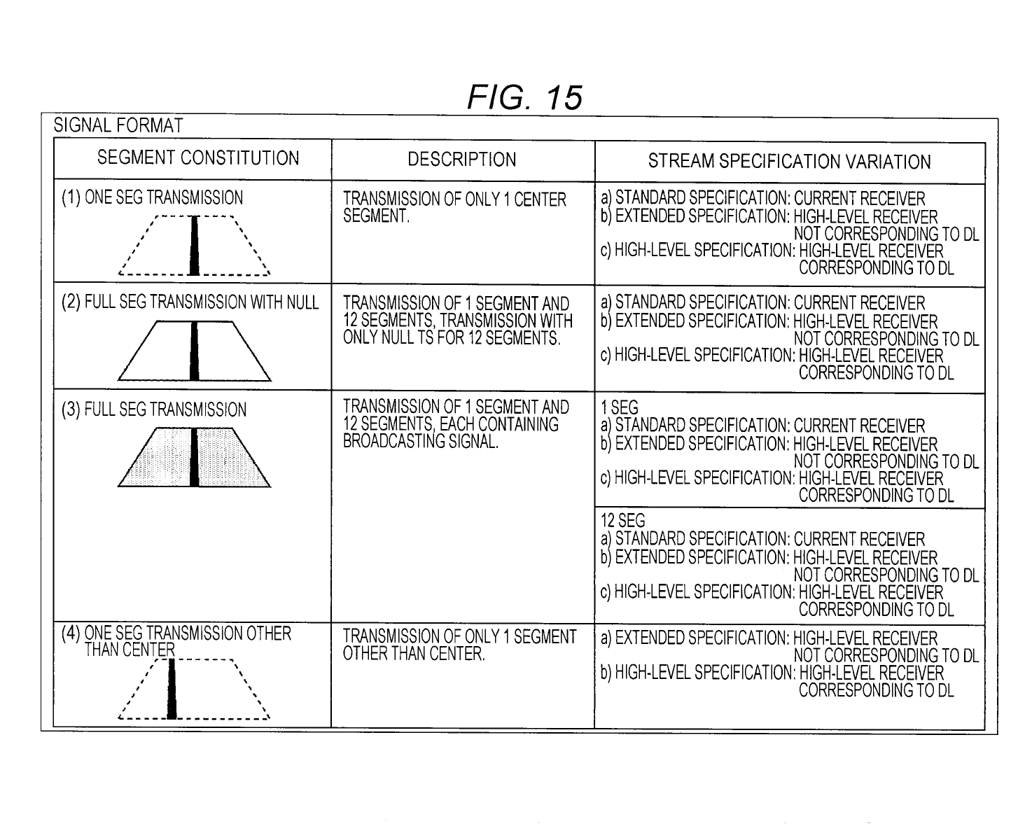

The signal format (signal_format) indicates the format of signals contained in broadcasting waves of area-limited broadcasting. The receiving terminal 33 identifies specifications of segment constitution and broadcasting stream based on the signal format. Any of following formats 1 through 4 is specified as the segment constitution as illustrated in FIG. 15, for example.

1: one seg transmission

2: full-seg transmission with null

3: full-seg transmission

4: one seg transmission other than center

The “one seg transmission” in this context refers to a segment constitution for transmission only using a center segment included in 13 segments of a physical channel.

The “full-seg transmission with null” in this context refers to a segment constitution for transmission using the 12 segments other than the center segment as well as the center segment. In this case, a TS as a null value is transmitted at each of the 12 segments.

The “full-seg transmission” is a segment constitution for transmission using the 12 segments other than the center segment as well as the center segment. In this case, a TS containing signals of broadcast is transmitted at each of the 12 segments other than the center segment, unlike the “full-seg transmission with null”.

The “one seg transmission other than center” in this context refers to a segment constitution for transmission using only arbitrary one segment included in the 12 segments other than the center segment.

The stations 32 provide area-limited broadcasting by using any of the foregoing four segment constitutions.

On the other hand, a receiver currently available (current receiver) does not necessarily deal with all these segment constitutions. Assuming that a specification corresponding to the current receiver is a “standard specification”, and that a specification corresponding to a high-level receiver having higher functions than those of the current receiver is an “extended specification” or a “high-level specification”, relationships indicated by “stream specification variation” in FIG. 15 are exhibited as the relationships between the receiver and the segment constitutions.

The “extended specification” in this context refers to a specification included in specifications in correspondence with high-level receivers and containing extended specifications such as improvement of a codec and the like. The “high-level specification” in this context refers to a specification corresponding to a service which handles downloaded broadcasting contents called time-shift broadcasting as viewing targets. Accordingly, in FIG. 15, a receiver for the “high-level specification” is represented as “high-level receiver corresponding to DL (Download)”, while a receiver for the “extended specification” is represented as “high-level receiver not corresponding DL (Download)”.

When the segment constitution is the “one seg transmission” or the“full-seg transmission with null” as shown in FIG. 15, the corresponding area-limited broadcasting is receivable by any of the current receiver, the high-level receiver not corresponding to DL, and the high-level receiver corresponding to DL.

When the segment constitution is the “full-seg transmission”, both the broadcasting at the center segment and the broadcasting at each of the 12 segments other than the center segment are receivable by any of the current receiver, the high-level receiver not corresponding to DL, and the high-level receiver corresponding to DL.

On the other hand, when the segment constitution is the “one seg transmission other than center”, the area-limited broadcasting is receivable by the high-level receiver not corresponding to DL, and the high-level receiver corresponding to DL.

As discussed above, the current receiver can receive area-limited broadcasting having the segment constitution of the “one seg transmission”, “full-seg transmission with null”, or “full-seg transmission”, but cannot receive area-limited broadcasting having the “one seg transmission other than center”. On the other hand, both the high-level receiver not corresponding to DL and the high-level receiver corresponding to DL can deal with all the segment constitutions.

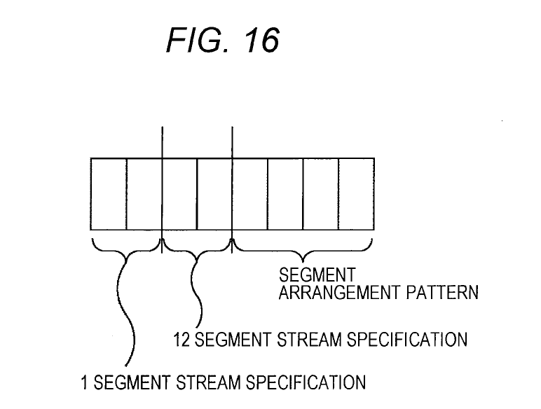

As illustrated in FIG. 16, 8 bits (each square represents a bit in the figure) are allocated for transmission of a signal format. Information concerning a specification of 1 seg stream is contained in the initial 2 bits in the 8 bits. Information concerning a specification of 12 seg stream is contained in the subsequent 2 bits, and information concerning segment arrangement patterns is contained in the subsequent 4 bits.

A value corresponding to the specification for transmission using 1 segment is specified as information concerning the specification of 1 seg stream. Accordingly, a value corresponding to any of the “standard specification”, the “extended specification”, and the “high-level specification” is specified for the initial 2 bits in all the segment constitutions.

A value corresponding to the specification for transmission using 12 segments is specified as information concerning the specification of 12 seg stream. Accordingly, a value corresponding to any of the “standard specification”, the “extended specification”, and the “high-level specification” is specified for the subsequent 2 bits only when the segment constitution is the “full-seg transmission”.

A value corresponding to any of the segment constitutions of the “one seg transmission”, the “full-seg transmission with null”, the “full-seg transmission”, and the “one seg transmission other than center” (for example, a value corresponding to any of 1 through 4) is specified as information concerning the segment arrangement patterns.

The receiving terminal 33 identifies the specifications of segment constitution and broadcasting stream based on the foregoing signal formats, and determines whether or not signals are contained in broadcasting waves of receivable area-limited broadcasting.

According to the example shown in FIG. 15, the standard specification”, the “extended specification”, and the “high-level specification” have been discussed as the specifications corresponding to receivers. However, this classification of the specifications is presented only by way of example, and other classifications may be adopted for the specifications.

According to the embodiment of the present technology, the case where the “one seg transmission” is specified as the segment constitution will be discussed for convenience of explanation.

Returning to FIG. 14, the transmission output (emission_power) shows transmission output (power (mW)) of broadcasting waves from the stations 32 identified by the station IDs.

The receiving terminal 33 can determine whether or not (signals of) broadcasting waves of area-limited broadcasting are receivable based on the transmission output and the positional relationships with the stations 32. Practically, however, the transmission output is dependent on the directivity of radio waves (broadcasting waves) and various radio wave propagation conditions, wherefore there is a (high) probability that area-limited broadcasting cannot be received (in a preferable state). Accordingly, it is assumed that the transmission output is used only secondarily.

The transmitting station latitude (station_latitude), the transmitting station longitude (station_longitude), and the transmitting station height (station_height) are position information representing the positions (locations) of the stations 32 identified by the station IDs, indicating the latitudes, longitudes, and heights of the locations of the stations 32 identified by the station IDs, respectively.

The transmitting station latitude and the transmitting station longitude show the north latitude and the east longitude, respectively, and represented by units of 0.00001 degree (corresponding to approximately 1 m accuracy), for example. The transmitting station height shows the height of the altitude from the surface of the earth or the height above the sea level, for example, and represented by units of 1 m, for example.

When there exist a plurality of transmission points (antennas) in each of the stations 32, any one of the transmission points, or a representative reference point, such as a center point, of the plural transmission points is designated as a transmission point. Alternatively, the range from the transmission output to the mobile station flag in FIG. 14 may be described with a loop individually for each of the existing plural transmission points.

When the receiving terminal 33 has a GPS (Global Positioning System) function, for example, it is assumed that the transmitting station latitude, the transmitting station longitude, and the transmitting station height are utilized for determining whether or not (signals of) broadcasting waves of area-limited broadcasting are receivable, and for displaying positions of the stations 32 on a map, notifying the probability of reception based on the relative distances from the stations 32, and other functions, for example.

The directivity pattern bit-map (directivity_pattern_bitmap) is information indicating the directivity of radio waves (broadcasting waves) transmitted in respective directions from each of the stations 32 corresponding to the centers. For example, the directivity pattern bit-map is created by dividing all directions into 16 sections around the center of the transmission point (antenna) of each of the stations 32, measuring radio waves transmitted in respective directions, and representing a value indicating the corresponding directivity by 2 bits, for example.

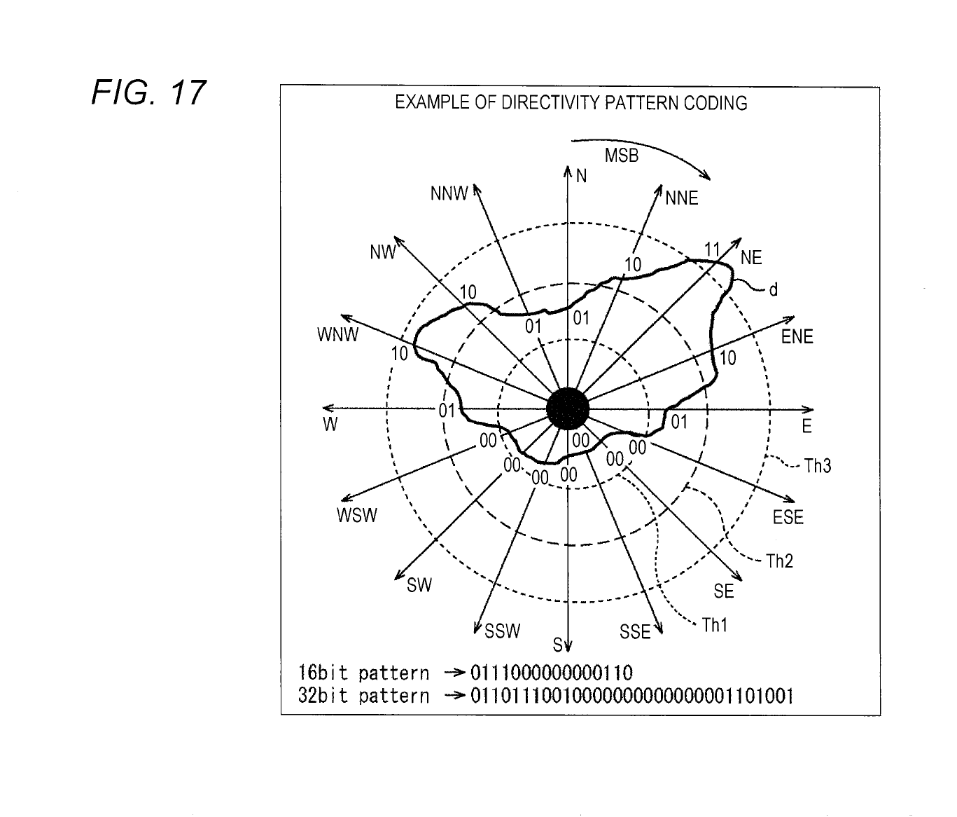

FIG. 17 is a figure showing an example of coding of directivity patterns. According to the example shown in FIG. 17, a value d indicating directivity in each direction in two dimensions of x and y is shown, with omission of a dimension of z in three dimensions for convenience of explanation.

As illustrated in FIG. 17, the values d indicating the directivities of radio waves (broadcasting waves) measured in all the directions are compared with thresholds Th1, Th2, and Th3 for each with respect to 16 directions of north (N), north-northeast (NNE), northeast (NE), east-northeast (ENE), east (E), east-southeast (ESE), southeast (SE), south-southeast (SSE), south (S), south-southwest (SSW), southwest (SW), west-southwest (WSW), west (W), west-northwest (WNW), northwest (NW), and north-northwest (NNW), and represented by 2 bits.

For example, as for each of the values d indicating the directivities of east-southeast (ESE), southeast (SE), south-southeast (SSE), south (S), south-southwest (SSW), southwest (SW), and west-southwest (WSW), a relation d≦Th1 holds. In this case, the d is represented by “00” in 2 bits. As for each of the values d indicating the directivities of north (N), east (E), west (W), and north-northwest (NNW), a relation Th1<d≦Th2 holds. In this case, the d is represented by “01” in 2 bits.

Moreover, for example, as for each of the values d indicating the directivities of north-northeast (NNE), east-northeast (ENE), west-northwest (WNW), and northwest (NW), a relation Th2<d≦Th3 holds. In this case, the value d is represented by “10” in two bits. As for the value d indicating the directivity of northeast (NE), a relation Th3<d holds. In this case, the d is represented by “11” in 2 bits.

When the bits in the respective directions are sequentially arranged clockwise from north (N) in accordance with MSB (Most Significant Bit), representation of 16-bit patterns such as “0111000000000110” is allowed as shown in a low part in FIG. 17. Similarly, when the bits in the respective directions are sequentially arranged clockwise from north (N), representation of 32-bit patterns such as “01101110010000000000000001101001” is allowed.

According to this example, 16-bit and 32-bit patterns are shown as the directivity pattern bit-map. However, other patterns such as 48-bit pattern may be adopted. When the number of bits of the patterns rises, the number of divisions of directions, and the number of allocations of bits corresponding to directivities of the respective directions can increase, for example.

It is assumed that the directivity pattern bit-map is used when a selectable station is selected from the stations 32 transmitting broadcasting waves of area-limited broadcasting, for example.

Returning to FIG. 14, the estimated receivable distance (max_distance) shows a range assumed beforehand, where broadcasting waves of area-limited broadcasting from the stations 32 are receivable. The estimated receivable distance is represented by a distance between the transmission point (antenna) and each of the stations 32, such as by units of 10 m.

It is assumed that the estimated receivable distance is used when the selectable station is selected from the stations 32 transmitting broadcasting waves of area-limited broadcasting, for example.

When there exist a plurality of transmission points, a distance from any of these transmission points, or a representative reference point of the plural transmission points, such as a center point is specified as the estimated receivable distance.

The open air flag (open_air_flag) is a flag indicating whether or not the outdoor is a target of a service of area-limited broadcasting. For example, in the case of area-limited broadcasting targeted at areas of particular outdoor facilities such as parks, the open air flag is raised.

The closed space flag (closed_space_flag) is a flag indicating whether or not the indoor is a target of a service of area-limited broadcasting. For example, in the case of area-limited broadcasting targeted at areas of particular indoor facilities such as stores, the closed space flag is raised.

The mobile station flag (station_mobility_flag) is a flag indicating whether or not area-limited broadcasting is broadcasted from the corresponding station 32 at a fixed position. For example, in the case of area-limited broadcasting targeted at areas within vehicles such as trains and buses, the mobile station flag is raised.

The extended information flag (extended_info_flag) is a flag indicating whether or not extended information exists.

The extended information (extended_info( )) is future extended information. When such extended information exists, the extended information flag is raised.

The station information shown in FIG. 14 is presented byway of example only. The station information may include other information about the stations 32, such as area names showing names of areas corresponding to locations of the stations 32 or the broadcasting areas, station names corresponding to the names of the stations 32, center frequencies for channel selection of area-limited broadcasting provided by the stations 32.

The transmission output, the transmitting station latitude, the transmitting station longitude, the transmitting station height, the directivity pattern bit-map, and the estimated receivable distance included in the foregoing information of the station information and used for selecting a service of area-limited broadcasting provided by the stations transmitting broadcasting waves receivable at a predetermined position are particularly referred to as service area information as well.

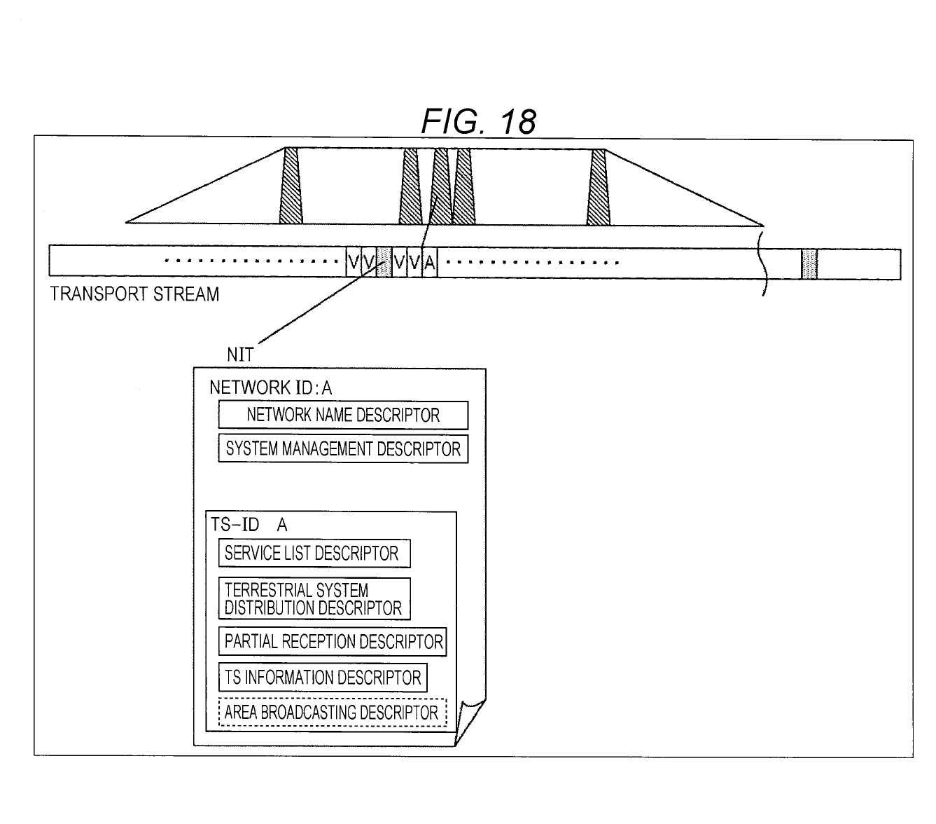

FIG. 18 is a figure illustrating an example of a syntax (data structure) of an NIT containing an area broadcasting descriptor.

As illustrated in FIG. 18, a network loop and a TS loop are sequentially arranged in an NIT extracted from a TS where video data, audio data and the like are multiplexed.

One or more descriptors (descriptors) can be arranged in the network loop. The descriptors of the network loop such as a network name descriptor and a system management descriptor are arranged for each network ID.

The network name descriptor describes a network name, while the system management descriptor describes information indicating whether the network is a broadcasting network or a communication network.

The TS loop is arranged next to the network loop. One or more descriptors (descriptors) can be arranged in the TS loop. The descriptors of the TS loop such as a service list descriptor, a terrestrial system distribution descriptor, a partial reception descriptor, a TS information descriptor, and an area broadcasting descriptor are arranged for each TS (TS-ID).

The service list descriptor describes a service ID, and a service type showing a type of broadcasting services (such as television broadcasting and radio broadcasting). The terrestrial system distribution descriptor describes information necessary for selection of frequencies (center frequency). The partial reception descriptor describes a service ID of a partial reception service (one seg broadcasting). The TS information descriptor describes allocation of remote control button numbers corresponding to the TS, and transmission hierarchy of services contained in the TS, and other information about the TS. The area broadcasting descriptor contains station information (FIG. 14) about the corresponding station 32.

When the station information about the station 32 is arranged in the area broadcasting descriptor, the receiving terminal 33 recognizes the TS as a service of area-limited broadcasting, and stores the station information. As a result, the receiving terminal 33 can notify that the station 32 is available in cooperation with a GPS function (described later) or the like, for example, when the receiving terminal 33 enters the broadcasting area of the corresponding station. Transmission of the station information about other area broadcasting stations is also conceivable. In this case, such a method may be adopted which determines the station information as information about other area broadcasting stations when the area broadcasting descriptor is arranged in the network loop of the NIT, and as information about the self-station when the area broadcasting descriptor is arranged in the TS loop. Alternatively, information indicating the self-station or the other stations may be contained in information items of the area broadcasting descriptor shown in FIG. 14.

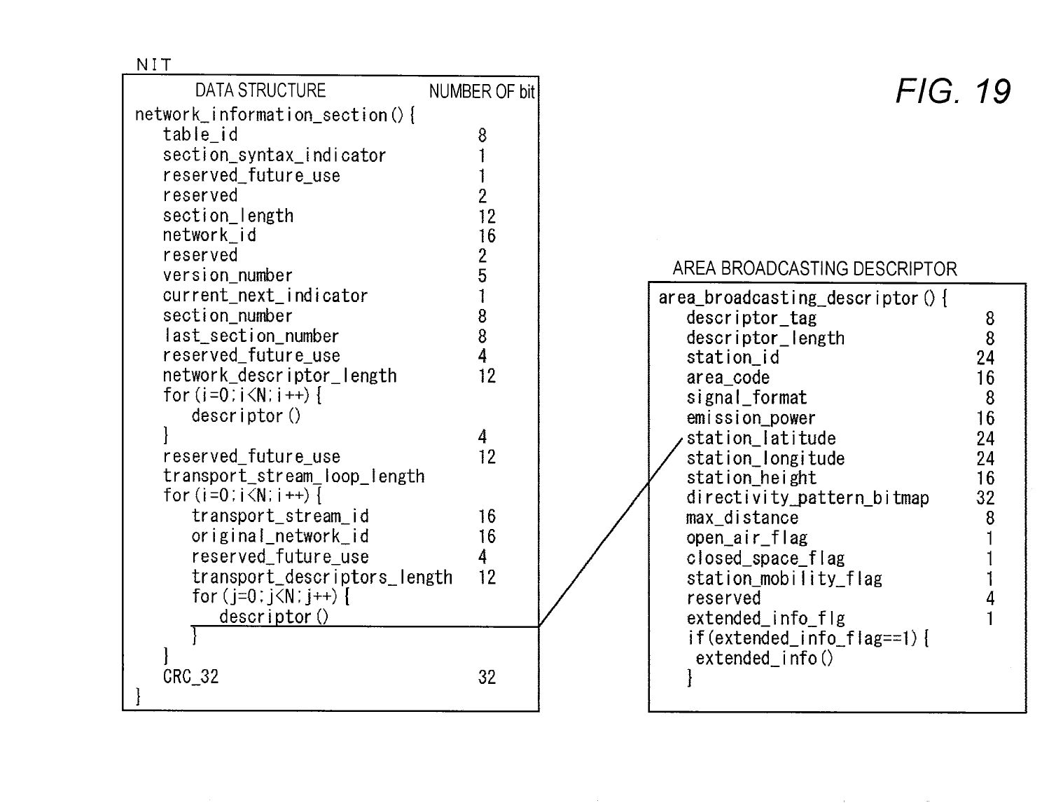

FIG. 19 illustrates a detailed example of the NIT and the area broadcasting descriptor shown in FIG. 18.

As illustrated in FIG. 19, respective items of the station information (FIG. 14) containing service area information are arranged in the area broadcasting descriptor (area_broadcasting_descriptor( )) contained in the TS loop of the NIT.

A descriptor_tag describes a tag value allocated to the corresponding descriptor. A descriptor_length describes a descriptor length of the corresponding descriptor.

A 24-bit station_id and 16-bit area_code describe a station ID and an area code, respectively. An 8-bit signal_format, and a 16-bit emission_power correspond to a signal format and a transmission output, respectively.

A 24-bit station_latitude, a 24-bit station_longitude, and a 16-bit station_height describe a transmitting station latitude, a transmitting station longitude, and a transmitting station height, respectively. A 32-bit directivity_pattern_bitmap, and an 8-bit max_distance describe a directivity pattern bit-map, and an estimated receivable distance, respectively.

A 1-bit open_air_flag, a 1-bit closed_space_flag, and a 1-bit station_mobility_flag describe an open air flag, a closed space flag, and a mobile station flag, respectively.

An extended_info( ) describes extended information. The extended_info( ) is arranged in the area broadcasting descriptor when the extended_info_flag is 1.

The describing method of the area broadcasting descriptor is arbitrarily determined, and not limited to the example shown in FIG. 19.

### [Constitution Example of Station 32]

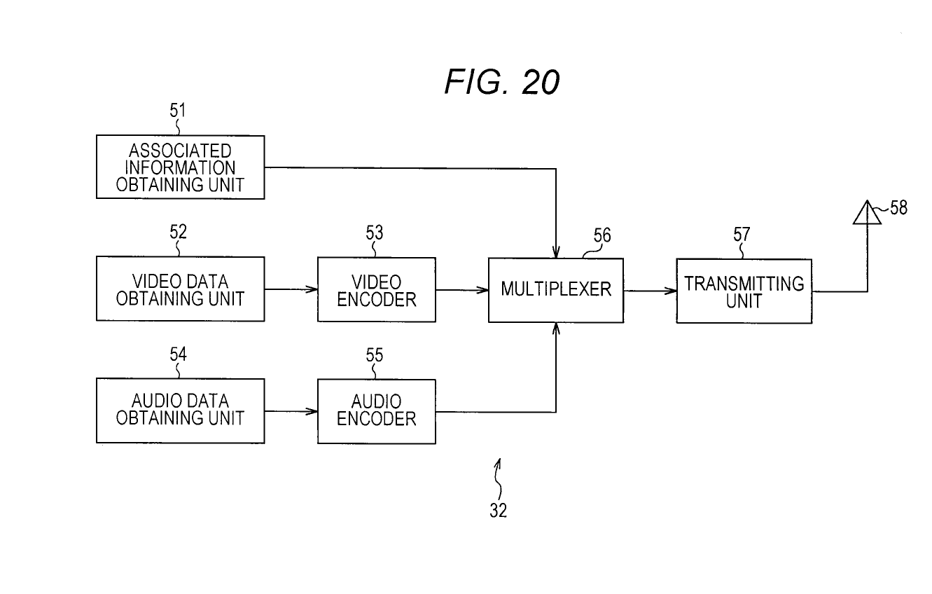

FIG. 20 is a block diagram showing a detailed constitution example of each of the stations 32 shown in FIG. 4.

In FIG. 20, the station 32 includes an associated information obtaining unit 51, a video data obtaining unit 52, a video encoder 53, an audio data obtaining unit 54, an audio encoder 55, a multiplexer 56, a transmitting unit 57, and an antenna 58.

The associated information obtaining unit 51 creates and obtains associated information including a PMT (Program Map Table) and a PAT (Program Association Table), information for receiving services containing an NIT (Network Information Table), an SDT (Service Description Table) and others, frequency information, PSI (Program Specific Information) corresponding to control information such as information for specifying packets corresponding to services, information (hereinafter referred to as display control information) for providing display using browsers in area-limited broadcasting, and others, and supplies the obtained information to the multiplexer 56.

The associated information obtaining unit 51 obtains station information to be included in an NIT when creating the NIT.

More specifically, when the station information about the station 32 is stored in a not-shown memory, the associated information obtaining unit 51 reads the station information from the memory to obtain the station information of the station 32.

When station information about a different station is to be included in the NIT, the associated information obtaining unit 51 downloads station information about the corresponding different station via a network from the corresponding different station to obtain the corresponding different station information, for example.

The video data obtaining unit 52 obtains video data of area-limited broadcasting from a not-shown built-in HDD (Hard Disk Drive), an external server, a camera, or others, and supplies the video data to the video encoder 53.

The video encoder 53 encodes the video data supplied from the video data obtaining unit 52 in conformity with an encoding system such as MPEG (Moving Picture Experts Group), and supplies the encoded data to the multiplexer 56.

The audio data obtaining unit 54 obtains audio data of area-limited broadcasting from the not-shown built-in HDD, the external server, a microphone (microphone), or others, and supplies the audio data to the audio encoder 55.

The audio encoder 55 encodes the audio data supplied from the audio data obtaining unit 54 in conformity with an encoding system such as MPEG, and supplies the encoded data to the multiplexer 56.

The multiplexer 56 creates a TS by multiplexing the associated information supplied from the associated information obtaining unit 51, the video data supplied from the video encoder 53, and the audio data supplied from the audio encoder 55, and supplies the created TS to the transmitting unit 57.

The transmitting unit 57 transmits the TS supplied from the multiplexer 56 at predetermined segments via the antenna 58.

As for the TS which is included in the TSs supplied from the multiplexer 56 and contains a multiplexed NIT including station information about the station 32 as associated information, this TS is transmitted at a representative segment of the station 32.

### [Description of Process Performed by Station 32]

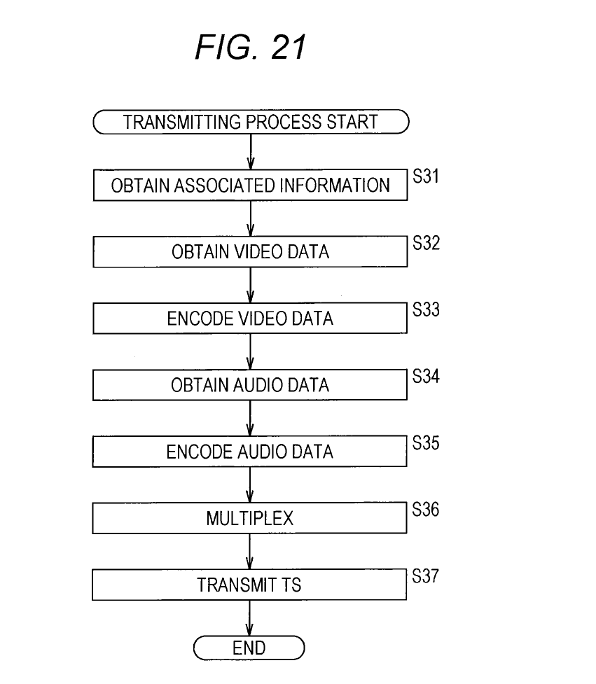

FIG. 21 is a flowchart describing a process (transmitting process) performed by the station 32 shown in FIG. 20.

In step S31, the associated information obtaining unit 51 obtains station information to be transmitted by the station 32, i.e., station information about the station 32 and station information about another station, and creates and obtains a PSI of area-limited broadcasting such as an EIT including the station information, display control information, and other associated information. Then, the associated information obtaining unit 51 supplies the created information to the multiplexer 56.

In step S32, the video data obtaining unit 52 obtains video data of area-limited broadcasting, and supplies the video data to the video encoder 53.

In step S33, the video encoder 53 encodes the video data supplied from the video data obtaining unit 52, and supplies the encoded data to the multiplexer 56.

In step S34, the audio data obtaining unit 54 obtains audio data of area-limited broadcasting, and supplies the audio data to the audio encoder 55.

In step S35, the audio encoder 55 encodes the audio data supplied from the audio data obtaining unit 54, and supplies the encoded data to the multiplexer 56.

In step S36, the multiplexer 56 multiplexes the associated information supplied from the associated information obtaining unit 51, the video data supplied from the video encoder 53, and the audio data supplied from the audio encoder 55 to create a TS.

In step S37, the transmitting unit 57 transmits the TS supplied from the multiplexer 56 at predetermined segments for transmission via the antenna 58, and the process ends.

### [Detailed Constitution Example of Receiving Terminal 33]

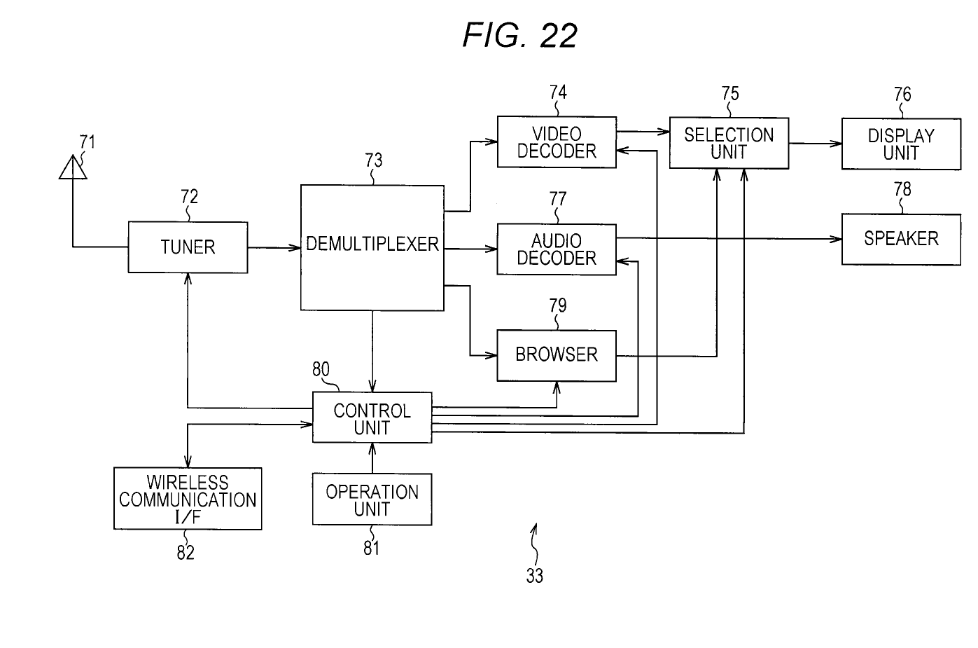

FIG. 22 is a block diagram showing a detailed constitution example of the receiving terminal 33 shown in FIG. 4.

In FIG. 22, the receiving terminal 33 includes an antenna 71, a tuner 72, a demultiplexer 73, a video decoder 74, a selection unit 75, a display unit 76, an audio decoder 77, a speaker 78, a browser 79, a control unit 80, an operation unit 81, and a wireless communication I/F 82.

The antenna 71 receives broadcasting waves in UHF band from the terrestrial broadcasting station 31 or the station 32, and supplies an IF (Intermediate Frequency) signal obtained by reception of the broadcasting waves to the tuner 72.

The tuner 72 selects (demodulates) (signals) of ordinary one seg broadcasting or area-limited broadcasting provided at a predetermined logic channel (segments) based on the IF signal supplied from the antenna 71 in accordance with the control of the control unit 80, and supplies a TS thus obtained to the demultiplexer 73.

The demultiplexer 73 separates the TS supplied from the tuner 72 into video data, audio data, display control information, respective information and the like of the PSI. The demultiplexer 73 supplies the video data to the video decoder 74, and supplies the audio data to the audio decoder 77. In addition, the demultiplexer 73 supplies the display control information to the browser 79, and supplies respective information and the like of the PSI to the control unit 80.

The video decoder 74 decodes the video data supplied from the demultiplexer 73 by a system corresponding to the video encoder 53 (FIG. 20) in accordance with the control of the control unit 80, and supplies the decoded data to the selection unit 75.

The selection unit 75 selects the video data supplied from the video decoder 74 or the video data supplied from the browser 79 in accordance with the control of the control unit 80, and supplies the selected data to the display unit 76.

In addition, the selection unit 75 supplies video data of images such as OSD (On Screen Display) to the display unit 76 in accordance with the control of the control unit 80.

The display unit 76 displays images and the like of ordinary one seg broadcasting or area-limited broadcasting based on the video data supplied from the selection unit 75.

The audio decoder 77 decodes the audio data supplied from the demultiplexer 73 by a system corresponding to the audio encoder 55 (FIG. 20) in accordance with the control of the control unit 80, and supplies the decoded data to the speaker 78.

The speaker 78 outputs voices corresponding to the audio data supplied from the audio decoder 77, i.e., voices of ordinary one seg broadcasting or area-limited broadcasting.

In addition to voices, the speaker 78 can output predetermined sound (such as beep sound) in accordance with the control of the control unit 80.

The browser 79 interprets display control information supplied from the demultiplexer 73, creates video data, and supplies the video data to the selection unit 75.

The control unit 80 performs various processes in accordance with operation signals and the like received from the operation unit 81, and controls respective blocks constituting the receiving terminal 33.

More specifically, the control unit 80 stores frequencies of center segments of respective physical channels of terrestrial digital broadcasting as preset frequencies for channel scanning, and performs channel selection control for allowing the tuner 72 to sequentially select (the segments of) the preset frequencies at the time of channel scanning.

The control unit 80 creates a channel selection table based on NIT actuals and SDT actuals at center segments of respective physical channels, NIT actuals, NIT others, SDT actuals, and SDT others contained in the PSI supplied from the demultiplexer 73, and stores the created channel selection table in a built-in memory (not shown).

The control unit 80 supplies service names registered in the channel selection table to the display unit 76 via the selection unit 75 in accordance with operation signals and the like from the operation unit 81, and displays the service names on the display unit 76.

In this case, the user can operate the operation unit 81 to select a service name of a service (logic channel) as a viewing target while checking service names displayed on the display unit 76.

The control unit 80 recognizes the frequency as the channel selection information about the service corresponding to the viewing target service name based on the channel selection table in accordance with the operation of the operation unit 81, and performs channel selection control for allowing the tuner 72 to select (the segment of) the frequency.

The control unit 80 controls the video decoder 74, the selection unit 75, the audio decoder 77, and the browser 79 based on the respective information contained in the PSI supplied from the demultiplexer 73. More specifically, the control unit 80 controls the video decoder 74 and the audio decoder 77 in such a manner that the video data outputted from the video decoder 74 and the audio data outputted from the audio decoder 77 can synchronize with each other.

The control unit 80 obtains station information when the station information is contained in the NIT of the PSI, and stores the station information as necessary.

Then, the control unit 80 performs channel selection control based on the station information.

More specifically, the control unit 80 selects a station of currently receivable area-limited broadcasting as a selectable station which is selectable based on the station information, and displays on the display unit 76 via the selection unit 75, the station name of the selectable station, and the service name of the service of the area-limited broadcasting provided by the selectable station.

The control unit 80 recognizes the frequency of (the service) of the area-limited broadcasting provided by the selectable station based on the station information or the channel selection table, and performs channel selection control for allowing the tuner 72 to select the frequency.

The operation unit 81 is operated by the user, and supplies operation signals corresponding to the operation to the control unit 80. The operation unit 81 includes physical buttons, and buttons displayed as GUI (graphics User Interface) on the display unit 76.

When a wireless IP access point is detected, the wireless communication I/F 82 connects to the Internet via the wireless IP access point in accordance with the control of the control unit 80. The wireless communication I/F 82 exchanges information with various servers connected with the Internet.

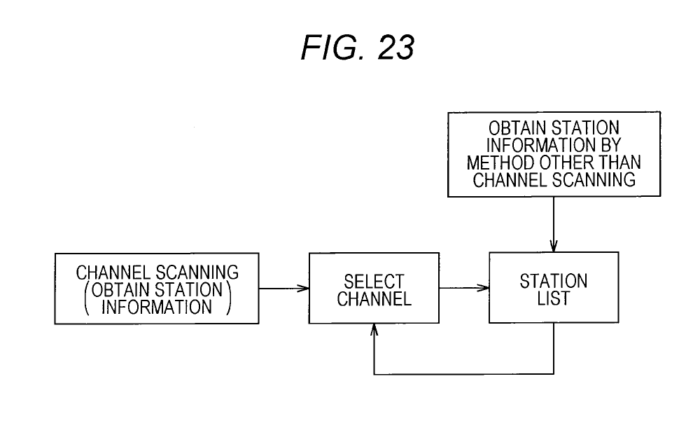

FIG. 23 is a figure describing obtainment and use of the station information by the receiving terminal 33 in FIG. 22.

As discussed above, the receiving terminal 33 can obtain station information from an NIT received at the time of channel scanning, for example, when the station 32 transmits the station information contained in the NIT.

Moreover, the receiving terminal 33 can obtain station information by methods other than channel scanning. For example, station information may be stored in a contactless IC card (such as Felica (registered trademark)) or other contactless media, and obtained by the receiving terminal 33 via near communication between the contactless medium and the receiving terminal 33 for exchange of station information.

Alternatively, station information may be stored as a file in a dedicated server on the Internet, and obtained by the receiving terminal 33 through wireless communication for exchange of station information between the server and the receiving terminal via wireless LAN (Local Area Network) or the like. In addition, station information may be obtained by the receiving terminal 33 by communication for exchange of the station information between the receiving terminal 33 and a personal computer which downloads the station information from a dedicated server on the Internet via a USB (Universal Serial Bus) or the like.

The receiving terminal 33 registers station information in a station list corresponding to a list in which the control unit 80 obtains and registers (stores) station information as necessary.

Then, the control unit 80 performs channel selection control based on station information.

### [Constitution Example of Control Unit 80]

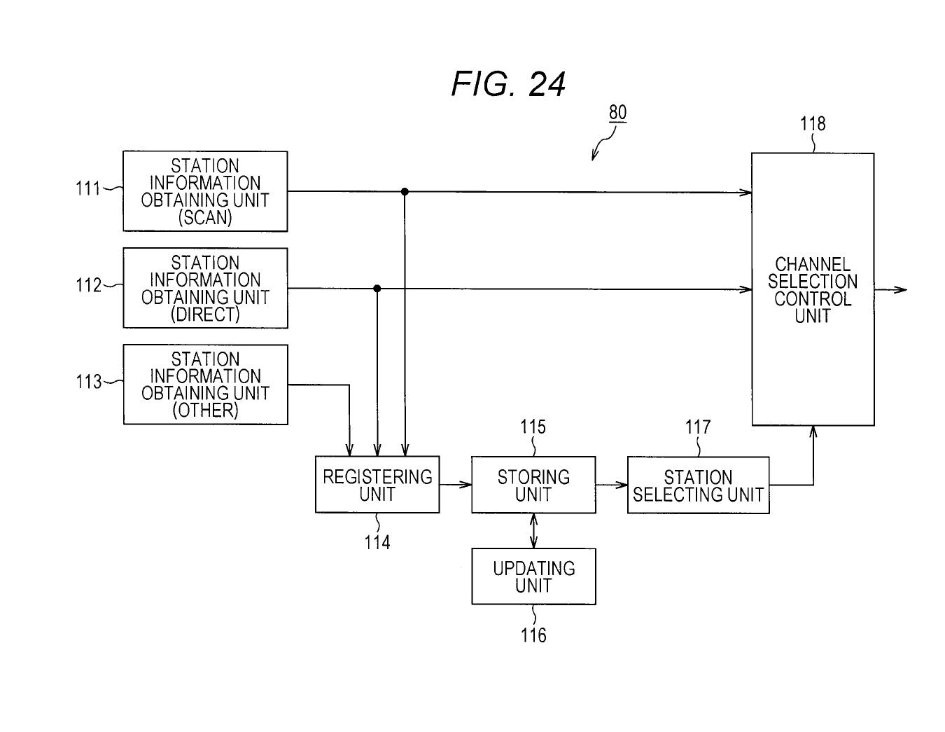

FIG. 24 is a block diagram showing a functional constitution example of a part of the control unit 80 in FIG. 22 performing channel selection control using station information.

In FIG. 24, the control unit 80 includes station information obtaining units 111, 112, and 113, a registering unit 114, a storing unit 115, an updating unit 116, a station selecting unit 117, and a channel selection control unit 118.

The station information obtaining units 111 through 113 obtain station information.

More specifically, the station information obtaining unit 111 obtains station information from an NIT obtained by channel scanning by the tuner 72 or by other methods, and supplies the station information to the registering unit 114 and the channel selection control unit 118.

In this case, the channel selection control unit 118 described later performs channel selection control for allowing the tuner 72 to sequentially select frequencies of center segments of respective physical channels of terrestrial digital broadcasting stored as preset frequencies when the operation unit 81 is operated to perform channel scanning.

The tuner 72 selects the preset frequencies in accordance with channel selection control of the channel selection control unit 118. When area-limited broadcasting is receivable at the selected preset frequency, i.e., when a TS of area-limited broadcasting is obtained as a result of channel selection, the tuner 72 supplies the obtained TS to the demultiplexer 73.

The demultiplexer 73 separates a PSI from the TS supplied from the tuner 72, and supplies the PSI to the control unit 80.

As described above, the control unit 80 creates a channel selection table where channel selection information about receivable services (area-limited broadcasting) at the moment is registered as necessary based on the NITs and SDTs contained in the PSIs supplied from the demultiplexer 73 at the time of channel scanning.

In addition, the station information obtaining unit 111 of the control unit 80 obtains station information from the NITs obtained at the time of channel scanning.

The station information obtaining unit 112 obtains station information by direct system, and supplies the station information to the registering unit 114 and the channel selection control unit 118.

When area-limited broadcasting provided by the station 32 is broadcasting concerning an event held within the broadcasting area of the station 32, a poster on which the station information about the station 32 is printed in the form of barcodes or the like, or a poster containing a wireless tag where the station information is stored may be displayed within the broadcasting area of the station 32.

In this case, the station information obtaining unit 112 contains a reading device for reading barcodes, or a reader-writer for performing near communication (contactless communication) with wireless tags, and obtains station information about the station 32 from a barcode or a wireless tag on a poster when the user brings the receiving terminal 33 close to the poster for obtaining the station information about the station 32.

As discussed above, the direct system is a station information obtaining system capable of obtaining only station information about the station 32 in the broadcasting area of the particular station 32.

The station information obtaining unit 113 obtains station information by channel scanning, and by a system other than direct system (other system), and supplies the station information to the registering unit 114.

More specifically, when station information about each of one or more stations is contained in the NITs of the TSs of the arbitrary one seg broadcasting or the ordinary one seg broadcasting in the condition of reception of arbitrary one seg broadcasting or ordinary one seg broadcasting by the tuner 72 (obtainment of TSs of arbitrary one seg broadcasting or ordinary one seg broadcasting), the station information obtaining unit 113 can obtain the corresponding station information.

When a Web server on the Internet provides station information about each of one or more stations for the receiving terminal 33 which has a function of Web browser, for example, the station information obtaining unit 113 can access the Web server and obtain the station information.

When the receiving terminal 33 is connected with a personal computer which has downloaded station information about each of one or more stations from a server providing the corresponding station information, for example, the station information obtaining unit 113 can obtain the station information from the personal computer.

When the user brings the receiving terminal 33 close to a printed matter (such as a poster, a catalogue, a magazine) containing station information about each of one or more stations in the form of barcode, or a printed matter containing a wireless tag storing station information about each of one or more stations to be presented to the user, the station information obtaining unit 113 can obtain the station information from the barcode or wireless tag contained in the printed matter.

The registering unit 114 supplies the station information supplied from the station information obtaining units 111 through 113 to the storing unit 115, and stores the station information in the storing unit 115 (registers the station information in a station list of the storing unit 115) as necessary.

More specifically, the registering unit 114 stores in the storing unit 115 only the station information required to be registered by the user in the station information supplied from the station information obtaining units 111 through 113.

In this case, there is a case when the user does not desire viewing of area-limited broadcasting received by the tuner 72 after the user viewed the corresponding area-limited broadcasting based on the channel selection control by the channel selection control unit 118 using the station information supplied from the station information obtaining unit 111.

In this case, the station information about the station providing the corresponding area-limited broadcasting is unnecessary.

In addition, when a number of pieces of station information containing such unnecessary station information are stored in the storing unit 115, a number of (station names of) stations are displayed on a station list screen described later. In this case, selection of a desired station may become difficult for the user.

For overcoming this problem, station information is allowed to be stored by the registering unit 114 in the storing unit 115 only by operation of the operation unit 81 (FIG. 22) by the user for requiring registration (hereinafter referred to as bookmark operation as well).

This structure avoids display of a number of stations on the station list screen, from which selection of a desired station becomes difficult for the user.

The storing unit 115 stores station information supplied from the registering unit 114. More specifically, the storing unit 115 retains the station list where station information is to be registered, and registers station information supplied from the registering unit 114 in the station list.

The updating unit 116 updates station information stored in the storing unit 115.

For example, the updating unit 116 updates station information stored in the storing unit 115 in accordance with the period for providing area-limited broadcasting to avoid display of a number of stations including stations not currently providing area-limited broadcasting on the station list screen, from which display selection of a desired station becomes difficult for the user.

The station selecting unit 117 selects stations providing area-limited broadcasting receivable at a predetermined position based on the station information stored in the storing unit 115, and determines the selected stations as selectable stations which are selectable, and then supplies the station information about the selectable stations to the channel selection control unit 118.

The channel selection control unit 118 performs channel selection control for allowing the tuner 72 (FIG. 22) to select area-limited broadcasting provided by the stations corresponding to the station information supplied from the station information obtaining units 111 and 112 and the station selecting unit 117 based on the corresponding station information.

The channel selection control unit 118 performs display control for controlling the selecting unit 75 to allow the display unit 76 (FIG. 22) to display the station list screen where station names of selectable stations are displayed, a channel list screen where service names of area-limited broadcasting (services) provided by the selectable stations are displayed, and others based on the station information about the selectable stations supplied from the station selecting unit 117.

[Process Performed by Receiving Terminal 33 for Obtaining Station Information]

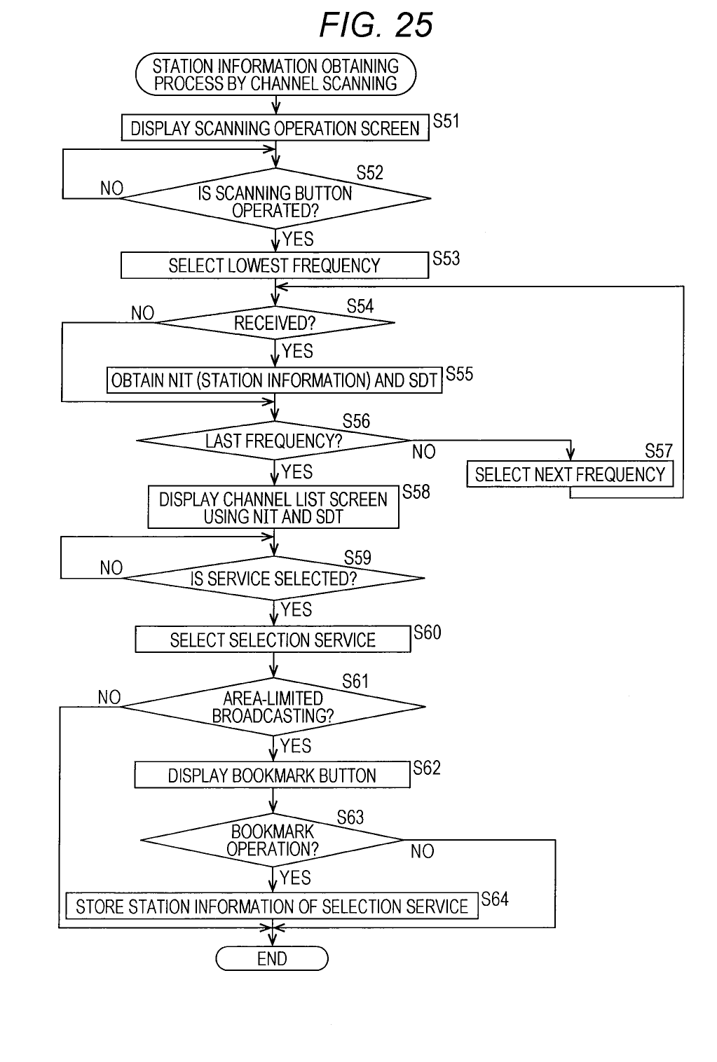

FIG. 25 is a flowchart describing a process performed by the receiving terminal 33 in FIG. 22 to obtain station information by channel scanning and receive a service.

When the user operates the operation unit 81 (FIG. 22) for display of a scanning operation screen corresponding to a menu screen of channel scanning, for example, the channel selection control unit 118 (FIG. 24) allows the selecting unit 75 (FIG. 22) to display the scanning operation screen on the display unit 76 (FIG. 22) in step S51. Then, the process proceeds to step S52.

In step S52, the channel selection control unit 118 determines whether or not a scanning button on the scanning operation screen has been operated.

More specifically, the scanning button to be operated at the time of channel scanning is provided on the scanning operation screen. In step S52, whether or not the scanning button has been operated or not is determined.

When it is determined in step S52 that the scanning button has not been operated, the process returns to step S52.

When it is determined in step S52 that the scanning button has been operated, the process proceeds to step S53. In subsequent steps S53 through S57, channel scanning is performed to obtain NITs and SDTs, and further obtain station information.

More specifically, in step S53, the channel selection control unit 118 selects the lowest frequency of frequencies (preset frequencies) at center segments of respective physical channels of terrestrial digital broadcasting, and determines the selected frequency as a noted frequency, for example, and then performs channel selection control for allowing the tuner 72 to select the noted frequency.

Thereafter, the process proceeds from step S53 to step S54. In this step, the channel selection control unit 118 determines whether or not a service has been received at the noted frequency, i.e., determines whether or not a TS has been obtained by the tuner 72 as a result of channel selection.

When it is determined in step S54 that a service has not been received at the noted frequency, the process skips step S55 and proceeds to step S56.

When it is determined in step S54 that a service has been received at the noted frequency, the process proceeds to step S55. In this step, the control unit 80 obtains an NIT and an SDT, and further obtains station information if possible.

More specifically, when the tuner 72 selects the noted frequency in accordance with the channel selection control of the channel selection control unit 118, and obtains a TS as a result of the selection, the tuner 72 supplies the TS to the demultiplexer 73. Then, the demultiplexer 73 separates a PSI from the TS received from the tuner 72, and supplies the PSI to the control unit 80.

The control unit 80 obtains NITs and SDTs contained in PSIs supplied from the demultiplexer 73 in the foregoing manner, and creates a channel selection table where channel selection information about services (area-limited broadcasting and ordinary one seg broadcasting) receivable at the moment are registered as necessary.

Furthermore, the station information obtaining unit 111 of the control unit 80 obtains station information from the NITs obtained from the PSIs from the demultiplexer 73 when the NITs contain the station information.

In this case, the frequencies (center frequencies) at which the stations corresponding to the station information obtained from the NITs are providing area-limited broadcasting can be recognized based on the NITs containing the station information. However, it is assumed herein that the center frequencies are contained in the station information for simplifying the explanation.

When the station information obtaining unit 111 obtains the NITs and the SDTs in step S55, and further obtains the station information in the foregoing manner in step S55, the station information obtaining unit 111 supplies the NITs and the SDTs and further the station information to the channel selection control unit 118, and supplies the station information to the registering unit 114. Then, the process proceeds to step S56.

In step S56, the channel selection control unit 118 determines whether or not the noted frequency is the last frequency in the preset frequencies, i.e., the highest frequency in this example.

When it is determined in step S56 that the noted frequency is not the last frequency in the preset frequencies, the process proceeds to step S57. In this step, the channel selection control unit 118 selects the second highest frequency next to the current noted frequency as a new noted frequency.

Moreover, in step S57, the channel selection control unit 118 performs channel selection control for allowing the tuner 72 to select the noted frequency. Then, the process returns to step S54.

When it is determined in step S56 that the noted frequency is the last frequency in the preset frequencies, the process proceeds to step S58.

According to the channel selection control performed by the channel selection control unit 118 for controlling the tuner 72 in steps S53 through S57, the tuner 72 may be allowed to not only select the frequency (preset frequency) of the center segment of each physical channel of terrestrial digital broadcasting, but also sequentially select frequencies of the respective segments of each physical channel.

In step S58, the channel selection control unit 118 creates a channel list screen displaying all of (or a part of) service names of services recognized based on the NITs and the SDTs received from the station information obtaining unit 111 through channel scanning, and displays the channel list screen on the display unit 76 via the selection unit 75.

Then, the process proceeds from step S58 to step S59. In this step, the channel selection control unit 118 determines whether or not the operation unit 81 has been operated to select any of the service names (logic channels) displayed on the channel list screen.

When it is determined in step S59 that the operation unit 81 has not been operated to select any of the service names displayed on the channel list screen, the process returns to step S59.

When it is determined in step S59 that the operation unit 81 has been operated to select any of the service names displayed on the channel list screen, the process proceeds to step S60. In this step, the channel selection control unit 118 performs channel selection control which selects a selection service (logic channel) (segment) corresponding to the service having the service name selected by the operation of the operation unit 81.

More specifically, the channel selection control unit 118 recognizes the frequency of the selection service (at which one seg broadcasting is provided) based on the NIT of the selection service (or already created channel selection table if possible).

Then, the channel selection control unit 118 allows the tuner 72 (FIG. 22) to select the frequency of the selection service.

The tuner 72 selects the selection service in accordance with the channel selection control by the channel selection control unit 118. When one seg broadcasting is receivable, i.e., when a TS of one seg broadcasting is obtained as a result of channel selection, the tuner 72 supplies the TS to the demultiplexer 73 (FIG. 22).

The demultiplexer 73 separates video data, audio data, and display control information from the TS supplied from the tuner 72, and supplies the separated data and information to each of the video decoder 74, the audio decoder 77, and the browser 79.

As a result, images and voices of the selection service are displayed on the display unit 76, and are outputted from the speaker 78, respectively, for example, so that the user can view the selection service.

Thereafter, the process proceeds from step S60 to step S61. In this step, the channel selection control unit 118 determines whether or not the selection service is a service of area-limited broadcasting included in one seg broadcasting.

In this case, the determination whether or not the selection service is a service of area-limited broadcasting included in one seg broadcasting can be made based on determination whether the NIT of the selection service contains station information, for example.

When it is determined in step S61 that the selection service is not a service of area-limited broadcasting, i.e., when it is determined that the NIT of the selection service does not contain station information, and therefore that the selection service is a service of ordinary one seg broadcasting, the process skips steps S62 through S64, and then ends.

When it is determined in step S61 that the selection service is a service of area-limited broadcasting, i.e., when it is determined that the NIT of the selection service contains station information, the process proceeds step S62. In this step, the channel selection control unit 118 superimposes on an image of the selection service a bookmark button to be operated at the time of request of registration of station information, and displays the bookmark on the display unit 76 via the selection unit 75.

Thereafter, the process proceeds from step S62 to step S63. In this step, the registering unit 114 determines whether or not the user has carried out bookmark operation for operating the bookmark button.

When it is determined in step S63 that the bookmark operation has been carried out, the process proceeds to step S64. In this step, the registering unit 114 registers in the station list of the storing unit 115 station information included in the station information from the station information obtaining unit 111 and concerning the station providing the area-limited broadcasting of the selection service. Then, the process ends.

On the other hand, when it is determined in step S63 that the bookmark operation has not been carried out, the process skips step S64, and ends.

Accordingly, the station information obtained by the station information obtaining unit 111 and concerning the station providing area-limited broadcasting of the selection service is registered in the station list of the storing unit 115 only when the bookmark operation has been carried out.

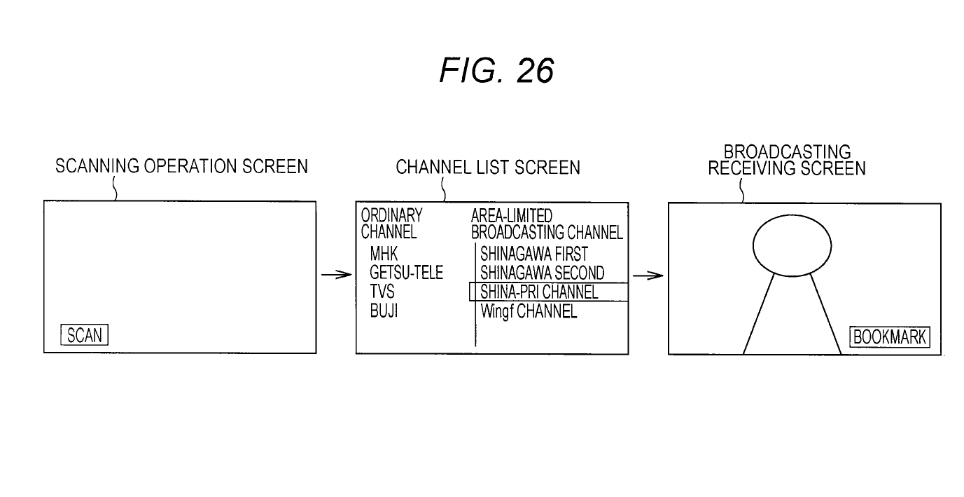

FIG. 26 is a figure illustrating a display example of the display unit 76 when the receiving terminal 33 in FIG. 22 obtains station information by channel scanning and receives a service.

As described with reference to FIG. 25, the scanning operation screen containing the scanning button is displayed on the display unit 76 of the receiving terminal 33 as illustrated in FIG. 26 when the user operates the operation unit 81 (FIG. 22) to display the scanning operation screen.

When the user operates the scanning button on the scanning operation screen displayed on the display unit 76, the receiving terminal 33 performs channel scanning, and obtains NITs and SDTs.

Then, the station information obtaining unit 111 of the receiving terminal 33 obtains station information based on the NITs obtained at the time of channel scanning.

Moreover, the channel selection control unit 118 of the receiving terminal 33 creates and displays, on the display unit 76, a channel list screen which displays service names of services of one seg broadcasting based on the NITs and the SDTs obtained by channel scanning.

The channel list screen in FIG. 26 separately displays service names of services (ordinary channels) of one seg broadcasting, and service names of services (area-limited broadcasting channels) of area-limited broadcasting.

When the user selects any service name (logic channel) displayed on the channel list screen in the subsequent step, the tuner 72 of the receiving terminal 33 selects the service corresponding to the service name as a selection service to determine the selection service.

Then, the display unit 76 of the receiving terminal 33 displays a broadcasting receiving screen where an image of the selection service the TS of which has been received as a result of channel selection by the tuner 72.

When the selection service is a service of area-limited broadcasting, the broadcasting receiving screen further displays a bookmark button. When the bookmark button is operated, the registering unit 114 of the receiving terminal 33 registers in the station list of the storing unit 115 station information included in the station information obtained by the station information obtaining unit 111 and concerning the station providing the area-limited broadcasting corresponding to the selection service.

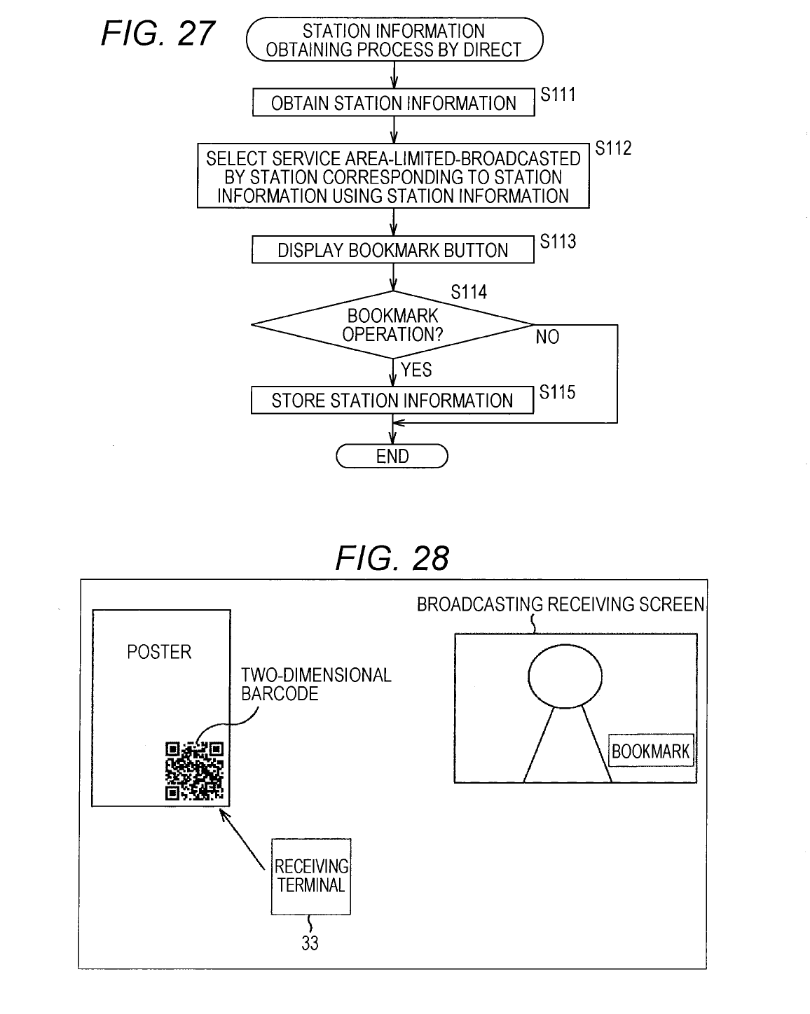

FIG. 27 is a flowchart describing a process performed by the receiving terminal 33 in FIG. 22 for receiving a service based on station information obtained by direct system.

For example, when the user operates the operation unit 81 to obtain station information by direct system, and brings the receiving terminal 33 close to a barcode printed on a poster in the form of a barcode for providing station information about a predetermined station, for example, the station information obtaining unit 112 (FIG. 24) reads the barcode and obtains the station information, and then supplies the station information to the registering unit 114 and the channel selection control unit 118 in step S111. Then, the process proceeds to step S112.

In step S112, the channel selection control unit 118 performs channel selection control for selecting a service area-limited-broadcasted at the center frequency of the station information supplied from the station information obtaining unit 112 based on the corresponding station information.

More specifically, the channel selection control unit 118 allows the tuner 72 (FIG. 22) to select the center frequency of the station information supplied from the station information obtaining unit 112.

The tuner 72 selects the center frequency in accordance with the channel selection control of the channel selection control unit 118. When area-limited broadcasting is receivable at the center frequency, i.e., when a TS of the area-limited broadcasting is obtained as a result of channel selection, the tuner 72 supplies the obtained TS to the demultiplexer 73.

The multiplexer 73 separates video data, audio data, and display control information of area-limited broadcasting from the TS supplied from the tuner 72, and supplies the separated data and information to each of the video decoder 74, the audio decoder 77, and the browser 79.

As a result, the display unit 76 displays images of the service (hereinafter referred to as direct obtaining service as well) area-limited-broadcasted at the center frequency of the station information obtained by the station information obtaining unit 112, while the speaker 78 outputs voices of the direct obtaining service. In this condition, the user can view the direct obtaining service.

Thereafter, the process proceeds from step S112 to step S113. In this step, the channel selection control unit 118 superimposes a bookmark button on an image of the direct obtaining service on the display unit 76 via the selection unit 75 similarly to the case in FIGS. 25 and 26. Then, the process proceeds to step S114.

In step S114, the registering unit 114 determines whether or not bookmark operation for operating the bookmark button has been carried out.

When it is determined in step S114 that the bookmark operation has been carried out, the process proceeds to step S115. In this step, the registering unit 114 registers in a station list of the storing unit 115 the station information supplied from the station information obtaining unit 112, i.e., the station information about the station providing area-limited broadcasting of the direct obtaining service. Then, the process ends.

When it is determined in step S114 that the bookmark operation has not been carried out, the process skips step S115, and ends.

Accordingly, the station information obtained by the station information obtaining unit 112 is registered in the station list of the storing unit 115 only when the bookmark operation has been carried out.

FIG. 28 is a figure illustrating a display example of the display unit 76 when the receiving terminal 33 in FIG. 22 obtains station information by direct system and receives a service.

When the user operates the operation unit 81 to obtain station information by direct system, and brings the receiving terminal 33 to a barcode printed in the form of barcode on a poster containing station information of a predetermined station, for example, the station information obtaining unit 112 (FIG. 24) of the receiving terminal 33 reads the barcode and obtains the station information. Then, the station information obtaining unit 112 supplies the station information to the registering unit 114 and the channel selection control unit 118.

The channel selection control unit 118 performs channel selection control for selecting a service (direct obtaining service) of area-limited broadcasting at the center frequency of the station information based on the station information supplied from the station information obtaining unit 112. The tuner 72 selects the direct obtaining service in accordance with the control of the channel selection control unit 118.

Then, the display unit 76 of the receiving terminal 33 displays a broadcasting receiving screen displaying an image of the direct obtaining service the TS of which has been received as a result of channel selection by the tuner 72.

The broadcasting receiving screen further displays a bookmark button. When the bookmark button is operated, the registering unit 114 of the receiving terminal 33 registers in the station list of the storing unit 115 the station information obtained by the station information obtaining unit 112 (station information about the station providing the area-limited broadcasting corresponding to the direct obtaining service).

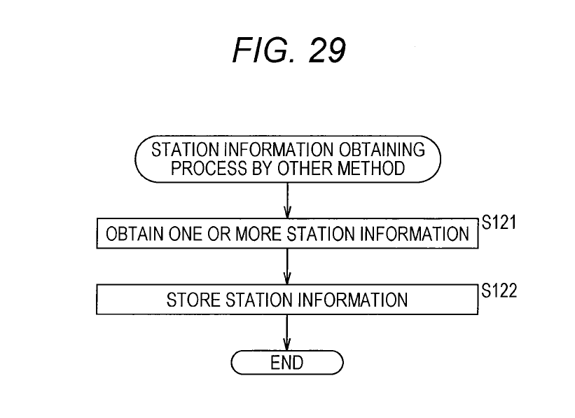

FIG. 29 is a flowchart describing a process performed by the receiving terminal 33 in FIG. 22 for obtaining station information by another system.

In step S121, the station information obtaining unit 113 (FIG. 24) obtains station information by other system as described with reference to FIG. 24, and supplies the station information to the registering unit 114. Then, the process proceeds to step S122.

In step S122, the registering unit 114 registers all the station information supplied from the station information obtaining unit 113 in the station list of the storing unit 115. Then, the process ends.

Accordingly, all the station information obtained by the station information obtaining unit 113 is registered in the station list of the storing unit 115.

However, similarly to the station information obtained by the station information obtaining units 111 and 112, only the station information in the station information obtained by the station information obtaining unit 113 and requested by the user for registration may be registered in the station list of the storing unit 115.

### [Channel Selecting Process Based on Station Information]

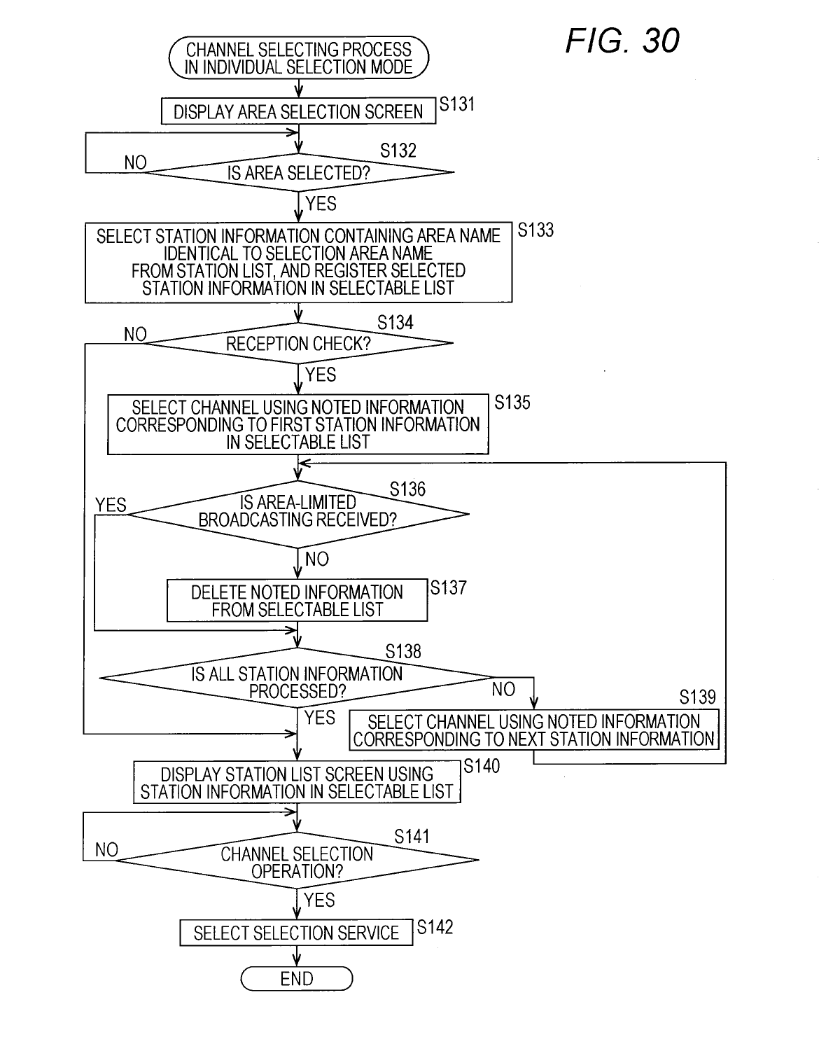

FIG. 30 is a flowchart describing a channel selecting process performed by the receiving terminal 33 for selecting a channel based on station information.

Modes for the channel selecting process include an individual selection mode, a sequential selection mode, a map display mode, and a GPS mode. The flowchart in FIG. 30 shows a channel selecting process in the individual selection mode.

Which mode is to be used for the channel selecting process can be selected by the user through operation of the operation unit 81, for example.

In step S131, the channel selection control unit 118 creates an area selecting screen, and displays the area selecting screen on the display unit 76.

More specifically, the station selecting unit 117 sequentially selects the station information registered in the station list of the storing unit 115 as noted station information to be noted, and selects an area name identified by the area code of the noted station information as a display area name to be displayed on the area selecting screen.

This area name corresponds to the name of the area of the location of the station 32 or of the broadcasting area identified by the area code (area specified name). The area name may be contained in the station information. Discussed herein is a case where the area name is contained in the station information.

The station selecting unit 117 does not select an area name identical to an area name already selected as a display area name, and does not determine this name as a display area name again.

When the station selecting unit 117 selects display area names of all the station information registered in the station list of the storing unit 115 as noted station information, the station selecting unit 117 supplies a table of these display area names to the channel selection control unit 118.

The channel selection control unit 118 creates an area selecting screen displaying the table of the display area names supplied from the station selecting unit 117, and displays the area selecting screen on the display unit 76.

When the area selecting screen is displayed in step S131, the process proceeds to step S132. In this step, the station selecting unit 117 determines whether or not any of the area names displayed on the area selecting screen as a display area name has been selected by the user through operation of the operation unit 81.

In this case, selection of a desired display area name may become difficult for the user when a number of display area names are displayed on the area selecting screen.

For overcoming this problem, the display area names displayed on the area selecting screen may be limited.

More specifically, when the station selecting unit 117 has a function for obtaining a current location such as GPS function, the station selecting unit 117 may supply only display area names close to the current location to the channel selection control unit 118 so that the display area names displayed on the area selecting screen can be limited to display area names within an area close to the current location.

When it is determined in step S132 that any of display area names displayed on the area selecting screen has not been selected, the process returns to step S132.

When it is determined in step S132 that any of the display area names displayed on the area selecting screen has been selected, the process proceeds to step S133. In this step, the station selecting unit 117 determines the display area name selected from the area selecting screen as a selection area name, and selects station information containing an area name identical to the selection area name from the station information registered in the station list of the storing unit 115.

Moreover, the station selecting unit 117 registers the station information selected from the station information registered in the station list of the storing unit 115 in a selectable list where station information about selectable stations is registered, and supplies the selectable list to the channel selection control unit 118. Then, the process proceeds to step S134.

In step S134, the channel selection control unit 118 determines whether or not to perform reception check of the station corresponding to the station information registered in the selectable list supplied from the station selecting unit 117, i.e., reception check of the selectable station (or area-limited broadcasting provided by the selectable station).

The reception check of the selectable station in this context refers to confirmation of actual reception of area-limited broadcasting (service) provided by the selectable station, i.e., confirmation of obtainment of a TS of area-limited broadcasting when the area-limited broadcasting provided by the selectable station is selected.

Whether or not to perform the reception check can be set by operation of the operation unit 81, for example.

When it is determined in step S134 that the reception check is not to be performed, the process skips steps S135 through S139, and proceeds to step S140 without reception check.

When it is determined in step S134 that the reception check is to be performed, the process proceeds to step S135. In this case, the reception check is performed in steps S135 through S139.

More specifically, in step S135, the channel selection control unit 118 selects the first station information in the selectable list supplied from the station selecting unit 117, and determines the selected information as noted station information (hereinafter referred to as noted information as well).

Moreover, in step S135, the channel selection control unit 118 performs channel selection control for allowing the tuner 72 to select a service area-limited-broadcasted at the center frequency of the noted station information based on the noted station information.

Thereafter, the process proceeds from step S135 to step S136. In this step, the channel selection control unit 118 determines whether or not the service area-limited-broadcasted at the center frequency of the noted station information has been received, i.e., whether a TS has been obtained by the tuner 72 as a result of channel selection.

When it is determined in step S136 that the service area-limited-broadcasted at the center frequency of the noted station information has not been received, the process proceeds to step S137. In this step, the channel selection control unit 118 deletes the noted station information from the selectable list. Then, the process proceeds to step S138.

More specifically, when the TS of the service of the area-limited broadcasting provided by the noted station cannot be received for the reason that the current location lies within the broadcasting area of the noted station as a station corresponding to the noted station information with a building or other obstacles interposed between the noted station and the current location, or that the current location is too far from the noted station, for example, the channel selection control unit 118 deletes the noted station information from the selectable list to remove the noted station from the selectable stations.

On the other hand, when it is determined in step S136 that the service area-limited-broadcasted at the center frequency of the noted station information has been received, the process skips step S137 and proceeds to step S138. In this step, the channel selection control unit 118 determines whether or not all the station information in the selectable list has been selected as noted station information.

When it is determined in step S138 that there remains station information not selected as noted station information in the station information contained in the selectable list, the process proceeds to step S139. In this step, the channel selection control unit 118 selects the station information subsequent to the station information corresponding to the current noted station information in the station information in the selectable list, and determines the selected station information as new noted station information.

Then, in step S139, the channel selection control unit 118 performs channel selection control for allowing tuner 72 to select a service area-limited-broadcasted at the center frequency of the noted station information based on the noted station information. Then, the process returns to step S136.

When it is determined in step S138 that all the station information in the selectable list has been selected as noted station information, i.e., when the reception check of all the station information in the selectable list has been completed, the process proceeds to step S140. In this step, the channel selection control unit 118 creates a station list screen, and displays the station list screen on the display unit 76.

More specifically, in step S140, the channel selection control unit 118 recognizes station names identified by station IDs of selectable stations based on the station information in the selectable list.

Then, the channel selection control unit 118 creates a station list screen corresponding to a list displaying a table of station names of selectable stations, and displays the station list screen on the display unit 76. Then, the process proceeds from step S140 to step S141.

In step S141, the channel selection control unit 118 determines whether or not the user has carried out channel selection operation. When it is determined that the channel selection operation has not been carried out, the process returns to step S141.

The channel selection operation in this context refers to operation for selecting a station and selecting a service area-limited-broadcasted by the station.

More specifically, the user can select a station name of a desired station (selectable station) from the station names displayed on the station list screen by operating the operation unit 81.

In step S141, it is determined whether or not the channel selection operation for selecting a station name of a selection station from the station names displayed on the station list screen has been carried out.

When it is determined in step S141 that the channel selection operation has been carried out, i.e., that a station has been selected from the station list screen as a selection station, and that a selection service has been selected, the process proceeds to step S142. In this step, the channel selection control unit 118 performs channel selection control for allowing the tuner 72 to select the selection service, and the channel selecting process in the individual selection mode ends.

As discussed above, the station information obtaining units 111 through 113 of the receiving terminal 33 obtain station information, and the storing unit 115 stores the station information.

Then, the station selecting unit 117 selects stations having area names identical to a display area name selected by the user, i.e., stations providing receivable area-limited broadcasting at the position of the display area name selected by the user as selectable stations which are selectable, based on area names contained in the station information stored in the storing unit 115. The selected station names are registered in the selectable list.

Thereafter, the channel selection control unit 118 displays a station list screen displaying station names registered in the selectable list as information about selectable stations, and performs channel selection control for selecting a service (selection service) area-limited-broadcasted by the selectable station selected by the user from the station list screen.

Accordingly, the receiving terminal 33 can rapidly presents area-limited broadcasting (service) receivable at the position of the display area name selected by the user in the form of the station list screen after obtaining station information.

When the reception check is not performed, there is a possibility that a service area-limited-broadcasted by the selectable station selected by the user from the statin list screen cannot be received.

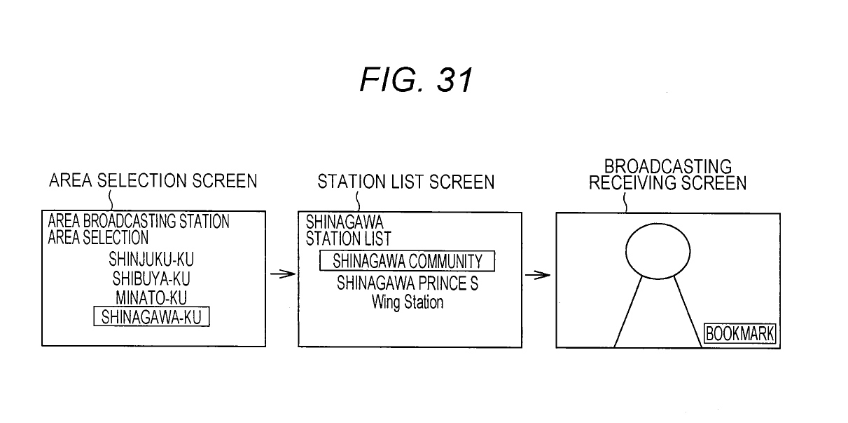

FIG. 31 is a figure illustrating a display example of the display unit 76 when the receiving terminal 33 in FIG. 22 performs the channel selecting process in the individual selection mode.

As discussed with reference to FIG. 30, in the individual selection mode, the area selecting screen showing area names of the station information as display area names is displayed on the display unit 76.

When the user selects any of the display area names displayed on the area selecting screen, stations corresponding to station information registered in the station list of the storing unit 115 and containing area names identical to a selection area name corresponding to the display area name selected from the area selecting screen are determined as selectable stations. Then, a station list screen displaying the station names of the selectable stations is displayed on the display unit 76.

In FIG. 31, display area names “Shinjuku-ku”, “Shibuya-ku”, “Minato-ku”, and “Shinagawa-ku” are displayed on the area selecting screen, and “Shinagawa-ku” is selected from the display area names.

In addition, in FIG. 31, three stations having station names of “Shinagawa Community”, “Shinagawa Prince S”, and “Wing Station” exist as stations having the area name of “Shinagawa-ku” in the station information. Thus, the station names of “Shinagawa Community”, “Shinagawa Prince S”, and “Wing Station” are displayed on the station list screen.

When the user selects any station name from the station names displayed on the station list screen, the display unit 76 displays a broadcasting receiving screen which shows images of selection services area-limited-broadcasted by selection stations corresponding to the stations (selectable stations) having station names selected by the tuner 72.

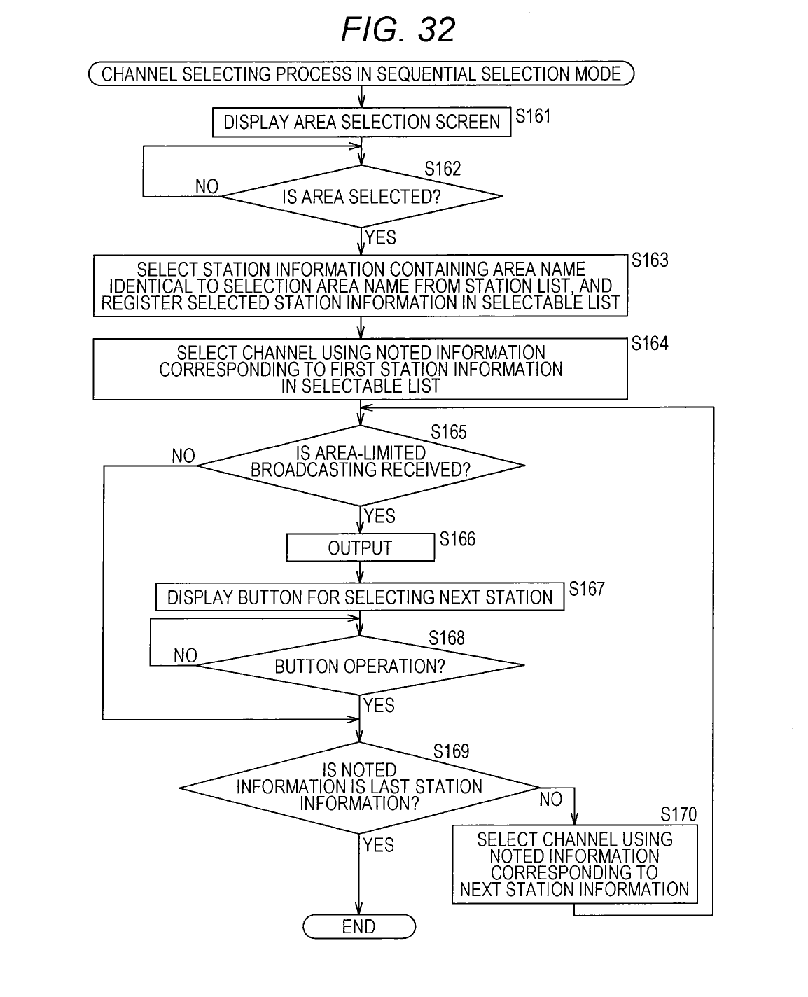

FIG. 32 is a flowchart describing a channel selecting process in the sequential selection mode performed by the receiving terminal 33 in the channel selecting processes for selecting channels based on station information.

According to the channel selecting process in the sequential selection mode, the same processes as in steps S131 through S133 in FIG. 30 are performed in steps S161 through S163.

More specifically, when the user selects an area name from area names displayed on an area selecting screen of the display unit 76 as a display area name, the display area name selected from the area selecting screen is determined as a selection area name. Then, station information containing area names or the like identical to the area name is selected as station information about selectable stations from station information registered in the station list of the storing unit 115. This station information is registered in the selectable list.

Subsequently, in step S164, the channel selection control unit 118 selects the first station information in the selectable list as noted station information.

In addition, in step S164, the channel selection control unit 118 performs channel selection control for allowing the tuner 72 to select a service area-limited-broadcasted at the center frequency of the noted station information based on the noted station information. Then, the process proceeds to step S165.

In step S165, the channel selection control unit 118 determines whether or not the service area-limited-broadcasted at the center frequency of the noted station information has been received, i.e., whether or not a TS has been obtained by the tuner 72 as a result of channel selection.

When it is determined in step S165 that the service area-limited-broadcasted at the center frequency of the noted station information has not been received, the process skips steps S166 through S168, and proceeds to step S169.

When it is determined in step S165 that the service area-limited-broadcasted at the center frequency of the noted station information has been received, the process proceeds to step S166. In this step, the channel selection control unit 118 allows output of the service area-limited-broadcasted at the center frequency of the noted station information from the display unit 76 and the speaker 78.

More specifically, the channel selection control unit 118 displays on the display unit 76 images of the service whose TS has been obtained by the tuner 72, and outputs voices of the service from the speaker 78.

Thereafter, the process proceeds from step S166 to step S167. In this step, the channel selection control unit 118 displays on the display unit 76 a “next ch” button for selecting a service area-limited-broadcasted by a station corresponding to the next station information in the selectable list, together with an image of the service area-limited-broadcasted at the center frequency of the noted station information. Then, the process proceeds to step S168.

In step S168, the channel selection control unit 118 determines whether or not the “next ch” button has been operated. When it is determined that the button has not been operated, the process returns to step S168.

When it is determined in step S168 that the “next ch” button has been operated, the process proceeds to step S169. In this step, the channel selection control unit 118 determines whether or not all the station information in the selectable list has been selected as noted station information.

When it is determined in step S169 that there remains station information not selected as noted station information in the station information of the selectable list, the process proceeds to step S170. In this step, the channel selection control unit 118 selects the station information subsequent to the station information corresponding to the current noted station information in the station information in the selectable list as new noted station information.

Then, in step S170, the channel selection control unit 118 performs channel selection control for allowing tuner 72 to select a service area-limited-broadcasted at the center frequency of the noted station information based on the noted station information. Then, the process returns to step S165.

When it is determined in step S169 that all the station information in the selectable list has been selected as noted station information, the channel selecting process in the sequential selection mode ends.

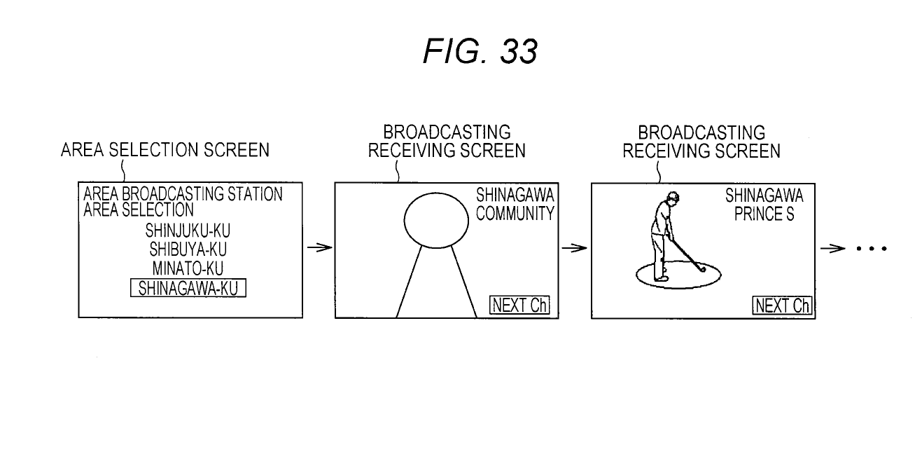

FIG. 33 is a figure illustrating a display example of the display unit 76 when the receiving terminal 33 in FIG. 22 performs the channel selecting process in the sequential selection mode.

As discussed with reference to FIG. 32, in the sequential selection mode, the area selecting screen showing area names of the station information as display area names is displayed on the display unit 76.

When the user selects any of the display area names displayed on the area selecting screen, stations corresponding to station information registered in the station list of the storing unit 115 and containing area names identical to a selection area name corresponding to the display area name selected from the area selecting screen are determined as selectable stations. The station information about the selectable stations is registered in the selectable list.

Then, the first station information in the selectable list is selected as noted station information. The service area-limited-broadcasted at the center frequency of the noted station information is selected.

When a TS of the service area-limited-broadcasted at the center frequency of the noted station information is obtained as a result of channel selection, a broadcasting receiving screen displaying images of the service are displayed on the display unit 76. In addition voices of the service are outputted from the speaker 78.

Then, the “next ch” button is displayed on the broadcasting receiving screen.

When the user operates the “next ch” button, station information subsequent to the station information corresponding to the current noted station information in the station information in the selectable list is selected as new noted station information. Then, a service area-limited-broadcasted at the center frequency of this noted station information is selected.

When a TS of the service area-limited-broadcasted at the center frequency of the noted station information is obtained as a result of channel selection, a broadcasting receiving screen displaying images of the service are displayed on the display unit 76. In addition voices of the service are outputted from the speaker 78.

Similarly to above, the “next ch” button is displayed on the broadcasting receiving screen. Thereafter, services area-limited-broadcasted by the selectable stations corresponding to the station information registered in the selectable list are sequentially selected every time the “next ch” button is operated in similar the manner.

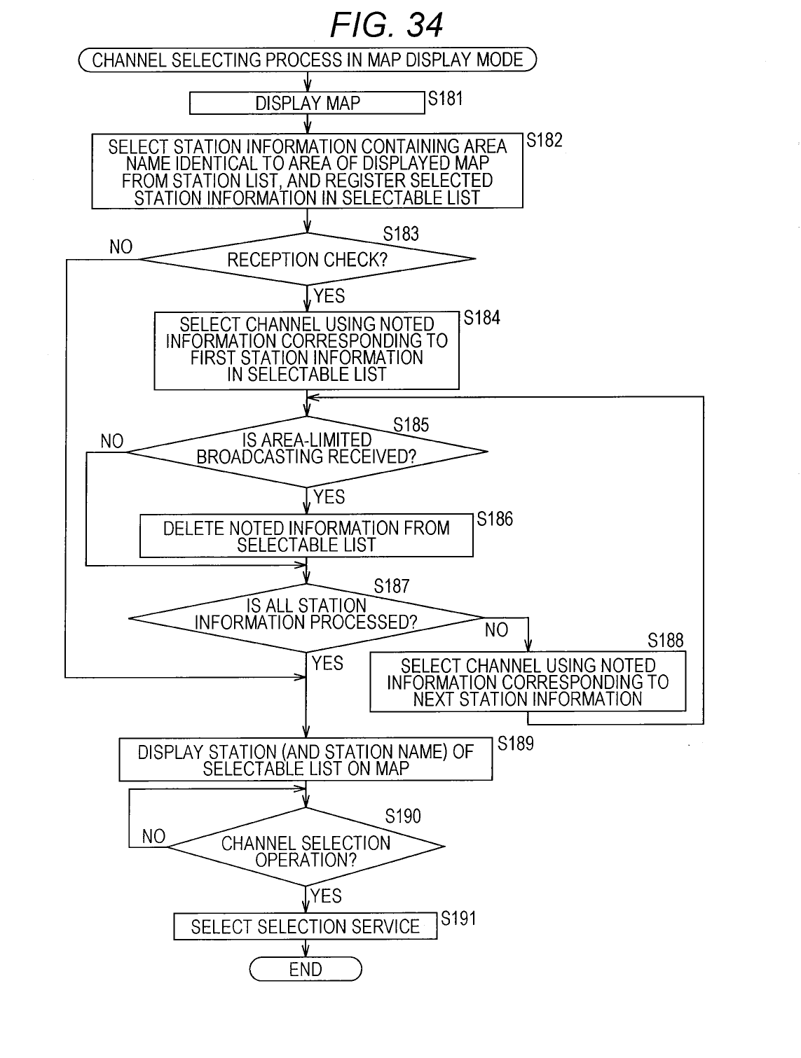

FIG. 34 is a flowchart describing a channel selecting process in the map display mode performed by the receiving terminal 33 in the channel selecting processes for selecting channels based on station information.

In step S181, the channel selection control unit 118 displays a map on the display unit 76 in accordance with operation by the user. Then, the process proceeds to step S182.

More specifically, the channel selection control unit 118 stores map data in a built-in memory. When the user operates the operation unit 81 to display a map of a predetermined area, for example, the channel selection control unit 118 displays the map of the predetermined area on the display unit 76 in accordance with the operation.

In step S182, the station selecting unit 117 determines names of areas contained in the map displayed on the display unit 76 as noted area names, and selects station information containing area names identical to the noted area names based on station information registered in the station list of the storing unit 115, similarly to step S133 shown in FIG. 30.

Moreover, the station selecting unit 117 registers station information selected from the station information registered in the station list of the storing unit 115 in a selectable list where station information about selectable stations is registered, and supplies the selectable list to the channel selection control unit 118. Then, the process proceeds to step S183.

In step S183, the channel selection control unit 118 determines whether or not to perform reception check similarly to step S134 in FIG. 30.

When it is determined in step S183 that the reception check is not to be performed, the process skips steps S184 through S188, and proceeds to step S189 without reception check.

When it is determined in step S183 that the reception check is to be performed, the process proceeds to step S184. Thereafter, the reception check is performed in steps S184 through S188 similarly to the processes in steps S135 through S139 in FIG. 30.

After the reception check is completed in steps S184 through S188, in step S189, the channel selection control unit 118 displays marks representing selectable stations on a map of the display unit 76 at the positions of the selectable stations indicated by transmitting station longitudes, transmitting station latitudes, and transmitting station heights included in the station information concerning the selectable stations as stations corresponding to the station information registered in the selectable list.

The display unit 76 may display station names of the selectable stations as well as the map and the marks representing the selectable stations.

Thereafter, the process proceeds from step S189 to step S190. In this step, the channel selection control unit 118 determines whether or not the user has carried out channel selection operation for selecting a station, and selecting a service area-limited-broadcasted by the station. When it is determined that the channel selection operation has not been carried out, the process returns to step S190.

More specifically, the user can select a desired station (selectable station) from stations whose marks or station names are displayed on the map of the display unit 76 by operation of the operation unit 81.

In step S190, it is determined whether or not channel selection operation has been carried out for selecting a station name of a selection station from choices of the selection stations on the map.

When it is determined in step S190 that the channel selection operation has been carried out, i.e., when a selection service has been selected after selection of a station on the map as a selection station, the process proceeds to step S191. In this step, the channel selection control unit 118 performs channel selection control for allowing the tuner 72 to select the selection service. Then, the channel selecting process in the map display mode ends.

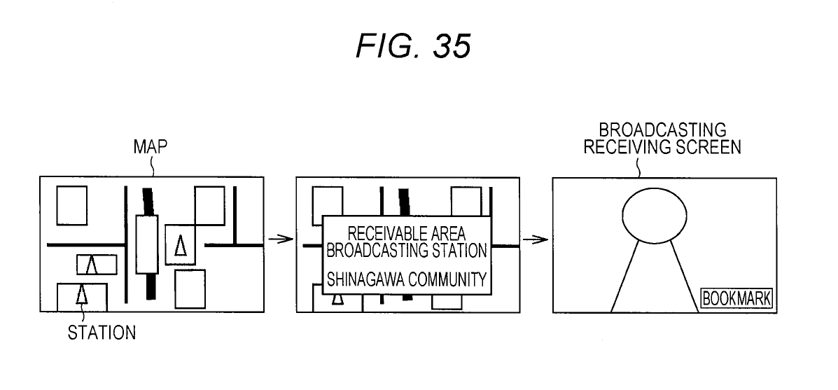

FIG. 35 is a figure illustrating a display example of the display unit 76 when the receiving terminal 33 in FIG. 22 performs the channel selecting process in the map display mode.

As discussed with reference to FIG. 34, in the map display mode, a map is displayed on the display unit 76.

Moreover, in the map display mode, marks representing selectable stations (triangular marks in FIG. 35) are displayed at the positions of the selectable stations on the map of the display unit 76.

When the user carries out operation of so-called focusing on a mark representing any of the selectable stations on the map, the station name of the selectable station corresponding to this mark (“Shinagawa Community” in FIG. 35) is displayed on the display unit 76 while superimposed on the map, for example.

When the user selects any of the selectable stations whose marks are displayed on the map, the tuner 72 receives a selection service area-limited-broadcasted by a selection station corresponding to the selectable station selected by the user. Then, the display unit 76 displays a broadcasting receiving screen displaying an image of the selection service.

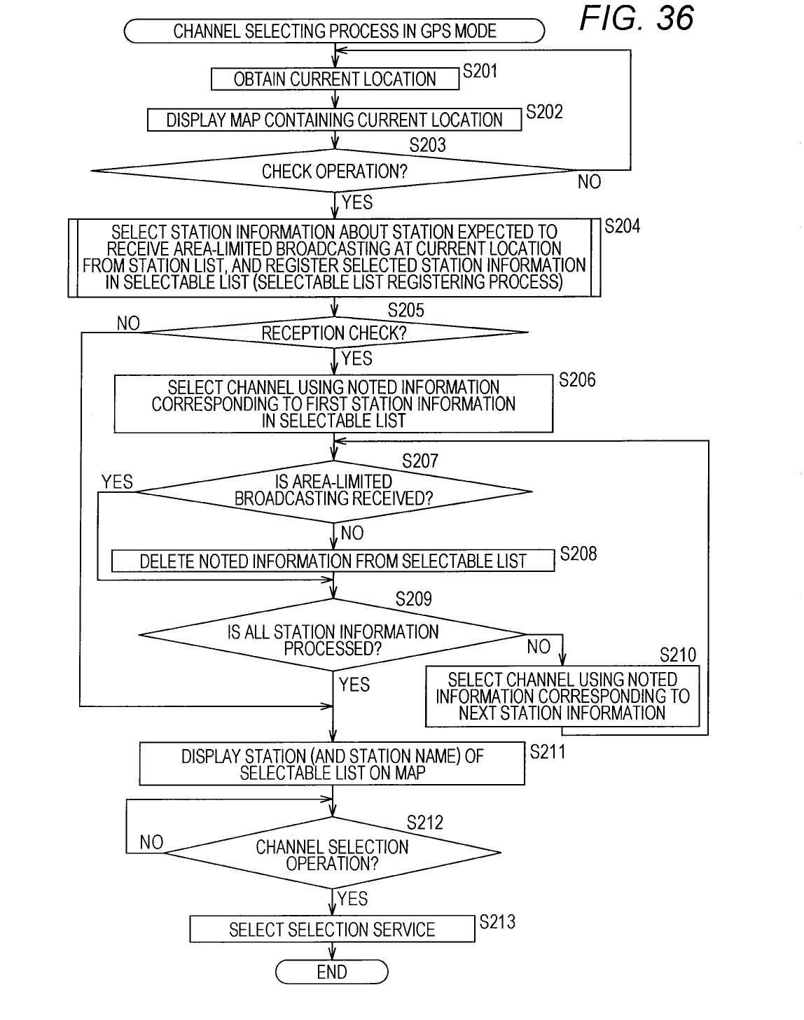

FIG. 36 is a flowchart describing the channel selecting process in GPS mode included in the channel selecting process in the receiving terminal 33 for selecting channels based on station information.

In performing the channel selecting process in the GPS mode, it is assumed that the station selecting unit 117 has a function of obtaining the current location, such as GPS, for example.

In step S201, the station selecting unit 117 obtains the current location (of the receiving terminal 33), and supplies the current location to the channel selection control unit 118. Then, the process proceeds to step S202.

In step S202, the channel selection control unit 118 displays on the display unit 76 a map containing the current location supplied from the station selecting unit 117. Then, the process proceeds to step S203.

More specifically, the channel selection control unit 118 which stores data of maps in a built-in memory displays on the display unit 76 a map of a predetermined range containing the current location supplied from the station selecting unit 117.

In step S203, the control unit 80 determines whether or not the user has operated the operation unit 81 to carry out check operation checking services of area-limited broadcasting receivable at the current location. When it is determined that the check operation has not been carried out, the process returns to step S201.

When it is determined in step S203 that the check operation has been carried out, the process proceeds to step S204. In this step, the station selecting unit 117 selects station information about stations providing area-limited broadcasting and expected to be receivable at the current location from the station information registered in the station list of the storing unit 115. Then, the station selecting unit 117 performs a selectable list registering process for registering the selected station information in the selectable list.

More specifically, in the selectable list registering process, selectable stations are selected from stations transmitting broadcasting waves of area-limited broadcasting in accordance with reception sensitivity calculated based on the service area information contained in the station information of the noted station. Then, the station information of the selectable stations is registered in the selectable list.

In addition, in the selectable list registering process, selectable stations are selected from stations transmitting broadcasting waves of area-limited broadcasting in accordance with receivable distances calculated based on the service area information contained in the station information of the noted station. Then, the station information of the selectable stations is registered in the selectable list.

The selectable list registering process performed in the foregoing manner will be detailed later.

Then, the process proceeds from step S204 to step S205. In this step, the channel selection control unit 118 determines whether or not to perform reception check of stations corresponding to the station information registered in the selectable list supplied from the station selecting unit 117, i.e., reception check of selectable stations (area-limited broadcasting provided by selectable stations), similarly to step S134 in FIG. 30.

When it is determined in step S205 that the reception check is not performed, the process skips steps S206 through S210, and proceeds to step S211 without reception check.

When it is determined in step S205 that the reception check is performed, the process proceeds to step S206. Then, the same processes as in steps S135 through S139 in FIG. 30 are executed in steps S206 through S210 to perform the reception check.

When the reception check ends in steps S206 through S210, the channel selection control unit 118 displays on the map of the display unit 76 marks and station names representing selectable stations as stations corresponding to the station information registered in the selectable list in step S211, similarly to step S189 in FIG. 34.

Thereafter, the process proceeds from step S211 to step S212. Then, the same processes as in steps S190 and S191 in FIG. 34 are performed in steps S212 and S213, and the channel selecting process in the GPS mode ends.

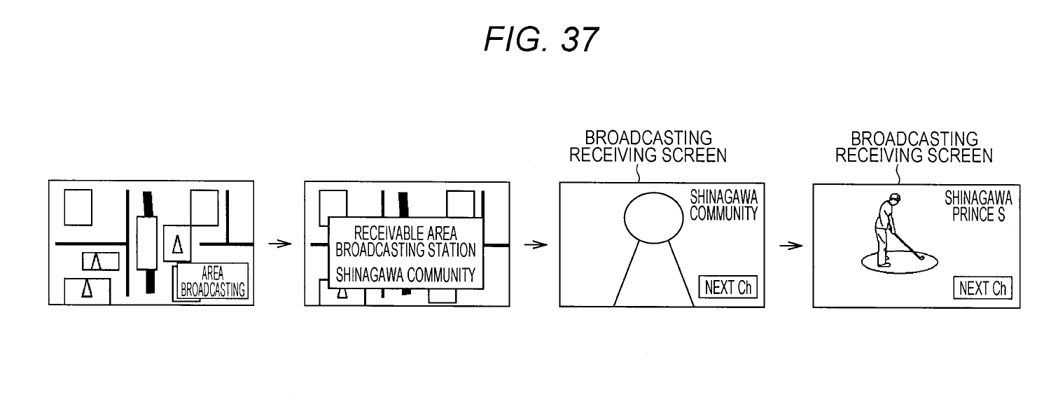

FIG. 37 is a figure illustrating a display example of the display unit 76 when the receiving terminal 33 in FIG. 22 performs the channel selecting process in the GPS mode.

In the GPS mode, a map around the current location is displayed on the display unit 76, for example.

Moreover, in the GPS mode, marks representing selectable stations (triangular marks in FIG. 37) are displayed at positions of selectable stations on the map of the display unit 76.

When the user performs operation of focusing a mark of any of the selectable stations on the map, the station name of the selectable station corresponding to the mark (“Shinagawa Community” and “Shinagawa Prince S” in FIG. 37) is displayed on the display unit 76 while superimposed on the map, for example, similarly to the case in FIG. 35.

When the user selects any of the selectable stations whose marks are displayed on the map, the tuner 72 receives a selection service area-limited-broadcasted from the selection station corresponding to the selectable station selected by the user. Then, a broadcasting receiving screen displaying an image of the selection service is displayed on the display unit 76.

When a plurality of selectable stations are present, a “next ch” button is also displayed on the broadcasting receiving screen.

When the user operates the “next ch” button, the receiving terminal 33 determines a new selection service corresponding to a selection service provided by a selectable station other than the current selection station, and selects the new selection service.

Thereafter, the broadcasting receiving screen showing an image of the new selection service is displayed on the display unit 76. In addition, the “next ch” button is displayed on the broadcasting receiving screen as necessary, similarly to the foregoing case.

In the selecting process in the GPS mode, a station list screen displaying only station names of selectable stations may be displayed without display of a map.

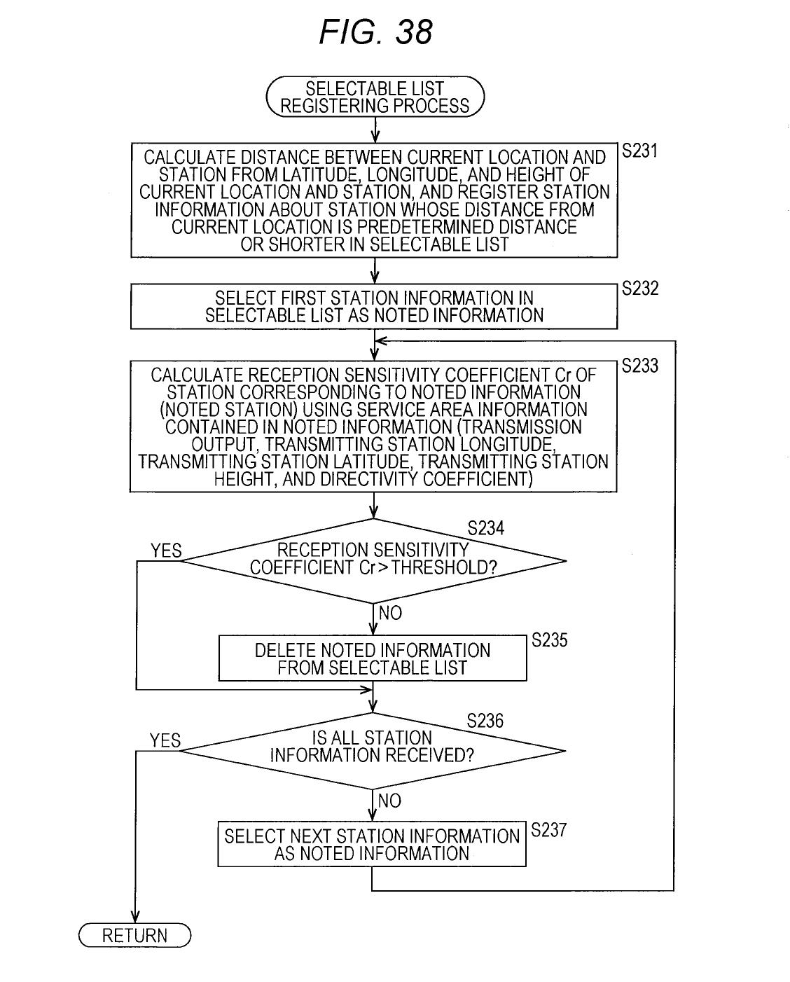

FIG. 38 is a flowchart describing the selectable list registering process performed in step S204 in FIG. 36.

According to the selectable list registering process in FIG. 38, the station selecting unit 117 sequentially selects stations corresponding to station information registered in the station list of the storing unit 115, and determines the selected stations as noted stations to be noted in step S231.

In addition, the station selecting unit 117 calculates the distance between the current location and the noted station based on the transmitting station longitude, the transmitting station latitude, and the transmitting station height of the station information of the noted station.

When the distance between the current location and the noted station is a predetermined value or less, the station selecting unit 117 registers the station information about the noted station in the selectable list while determining the noted station as (a choice of) selectable stations. The predetermined value may be an estimated receivable distance of the station information of the noted station.

As discussed above, the station selecting unit 117 performs pre-processing for (temporarily) registering the station information about the noted station in the selectable list based on the distance between the current location and the noted station.

When the station selecting unit 117 selects all the stations corresponding to the station information registered in the station list of the storing unit 115 as noted stations, and completes the pre-processing, the process proceeds from step S231 to step S232. Thereafter, the station selecting unit 117 performs a selecting process for selecting selectable stations (deleting station information about stations not to be selected as selectable stations from the selectable list) based on a reception sensitivity coefficient Cr (described later), targeting stations corresponding to the station information registered in the selectable list.

The foregoing pre-processing in step S231 in FIG. 38 may be omitted.

When the pre-processing in step S231 is omitted, the selecting process after step S232 needs to be executed not for the stations corresponding to the station information registered in the selectable list, but for all the stations corresponding to the station information registered in the station list of the storing unit 115.

Accordingly, when the pre-processing is omitted, the selecting process for calculating the reception sensitivity coefficient Cr (described later) and other processes need to be executed for all of the stations corresponding to the station information registered in the station list of the storing unit 115.

On the other hand, when the pre-processing is performed, the reception sensitivity coefficient Cr needs to be calculated only for the stations corresponding to the station information registered in the selectable list. As a result, the load of the selecting process can be decreased.

Accordingly, the pre-processing is, in other words, a process for “narrowing down” stations to be selected as targets for the selecting process.

In step S232, the station selecting unit 117 selects the first station information in the selectable list as noted station information (noted information). Then, the process proceeds to step S233.

In step S233, the station selecting unit 117 calculates the reception sensitivity coefficient Cr of the noted station as the station corresponding to the noted station information based on the transmission output, the transmitting station longitude, the transmitting station latitude, the transmitting station height, and a directivity coefficient of the noted station information. Then, the process proceeds to step S234.

The reception sensitivity coefficient Cr of the noted station in this context is a value corresponding to an index for determining whether or not area-limited broadcasting provided by the noted station is receivable at the current location at a value corresponding to the reception level of the broadcasting waves from the noted station at the time of reception of the broadcasting waves at the current location. The directivity coefficient is a coefficient calculated based on the directivity pattern bit-map (FIG. 17) corresponding to the noted station.

The reception sensitivity coefficient Cr of the noted station is calculated by following Equation (1), for example, assuming that the transmitting station longitude, the transmitting station latitude, and the transmitting station height are Sx, Sy, and Sz, that the longitude, the latitude, and the height of the current location are Rx, Ry, and Rz, and that the transmission output and the directivity coefficient of the noted station are Ep and f(dir), respectively.

$$\begin{matrix}[ Mathematical Formula 1 ] & \\ Cr = \frac{log ( Ep * f ( dir ) )}{\sqrt{{( Sx - Rx )}^{2} + {( Sy - Ry )}^{2} + {( Sz - Rz )}^{2}}} & ( 1 )\end{matrix}$$

In Equation (1), dir of f(dir) indicates a direction in the directivity pattern bit-map (FIG. 17) for a noted station. A directivity coefficient for bits allocated to a corresponding direction, for example, is calculated by calculation of this function. However, it is assumed that the foregoing dir extracts the closest direction from the current longitude and latitude of the current location and from the longitude and latitude of the noted station. In addition, “*” in Equation (1) means multiplication. A transmission output with directivity is calculated by calculation of log (Ep*f(dir)).

In step S234, the station selecting unit 117 determines whether or not the reception sensitivity coefficient Cr of the noted station is larger (equal to or larger) than a threshold θ.

The threshold θ is a value of a reception sensitivity coefficient at which broadcasting waves of area-limited broadcasting are receivable by the receiving terminal 33 in a preferable condition (for example, at a predetermined S/N(Signal to Noise Ratio)).

The reciprocal of the reception sensitivity coefficient Cr of the noted station corresponds to the radius of the circle of the broadcasting area of the noted station.

When it is determined in step S234 that the reception sensitivity coefficient Cr of the noted station does not exceed the threshold θ, i.e., when (it is highly probable that) the area-limited broadcasting provided by the noted station is not receivable (in a preferable condition) at the current location, the process proceeds to step S235. In this step, the station selecting unit 117 deletes the noted station information from the selectable list to remove the noted station from the selectable stations. Then, the process proceeds to step S236.

On the other hand, when it is determined in step S234 that the reception sensitivity coefficient Cr of the noted station exceeds the threshold θ, i.e., when (it is highly probable that) the area-limited broadcasting provided by the noted station is receivable (in a preferable condition) at the current location, the process skips step S235, i.e., without deleting the noted station information from the selectable list, and allows the noted station to be kept selected as a selectable station. Then, the process proceeds to step S236.

In step S236, the station selecting unit 117 determines whether or not all the station information in the selectable list has been selected as noted station information.

When it is determined in step S236 that there remains station information not selected as noted information in the station information contained in the selectable list, the process proceeds to step S237. In this step, the station selecting unit 117 selects the station information subsequent to the station information corresponding to the current noted station information in the station information in the selectable list as new noted station information.

Then, the process returns from step S237 to step S233, where similar processes are repeated.

When it is determined in step S236 that all the station information has been selected as noted station information, the selectable list registering process in FIG. 38 ends. Then, the process returns.

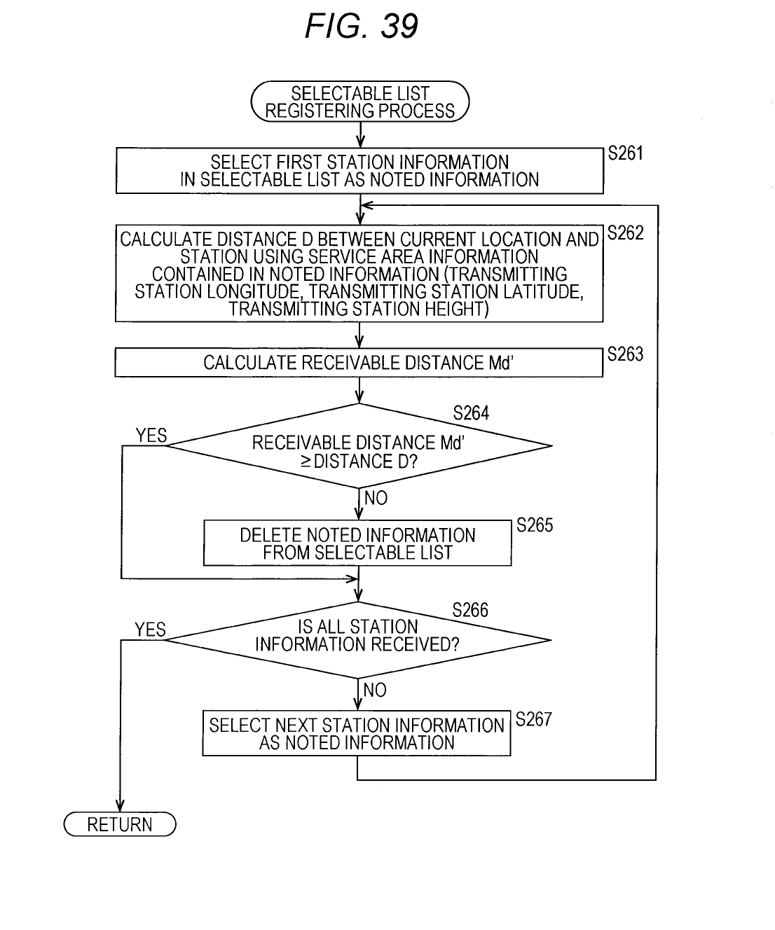

Discussed herein has been the example where whether or not station information is a target of the selectable list is determined based on reception sensitivity of a noted station. However, an index other than the aforementioned reception sensitivity may be adopted. FIG. 39 is a flowchart describing another example of the selectable list registering process performed in step S204 in FIG. 36.

According to the selectable list registering process in FIG. 39, the station selecting unit 117 selects the first station information in the selectable list as noted station information (noted information) in step S261. Then, the process proceeds to step S262.

In step S262, the station selecting unit 117 calculates a distance D between the current location and the station 32 based on the transmitting station longitude, the transmitting station latitude, and the transmitting station height of the noted station information. Then, the process proceeds to step S263.

The distance D is calculated by following Equation (2), for example, assuming that the transmitting station longitude, the transmitting station latitude, and the transmitting station height are Sx, Sy, and Sz, and that the longitude, the latitude, and the height of the current location are Rx, Ry, and Rz.

[Mathematical Formula 2]

D=\sqrt{(Sx−Rx)²+(Sy−Ry)²+(Sz−Rz)²} (2)

In step S263, the station selecting unit 117 calculates a receivable distance Md′ based on the estimated receivable distance of the noted station information and the directivity pattern bit-map. Then, the process proceeds to step S264.

The receivable distance Md′ of the noted station in this context is a value corresponding to a receivable range of broadcasting waves from the noted station. This value is an index for determining whether or not the area-limited broadcasting provided by the noted station is receivable at the current location.

The receivable distance Md′ of the noted station is calculated by following Equation (3), assuming that the estimated receivable distance of the noted station and the directivity coefficient are Md and f(dir), respectively.

[Mathematical Formula 3]

Md′=Md*f(dir) (3)

In Equation (3), “*” means multiplication. In this case, a receivable distance with directivity is calculated by calculation of Md*f(dir). The value f(dir) is the same as the above definition.

In step S264, the station selecting unit 117 determines whether or not the receivable distance Md′ is larger (equal to or larger) than the distance D.

When it is determined in step S264 that the receivable distance Md′ of the noted station does not exceed the distance D, i.e., when (it is highly probable that) the area-limited broadcasting by the noted station is not receivable (in a preferable condition) at the current location, the process proceeds to step S265. Then, the station selecting unit 117 deletes the noted station information from the selectable list to remove the noted station from the selectable stations. Then, the process proceeds to step S266.

On the other hand, when it is determined in step S264 that the receivable distance Md′ of the noted station exceeds the distance D, i.e., when (it is highly probable that) the area-limited broadcasting by the noted station is receivable (in a preferable condition) at the current location, the process skips step S265, i.e., without deleting the noted station information from the selectable list, and allows the noted station to be kept selected as a selectable station. Then, the process proceeds to step S266.

The same processes as in steps S236 and S237 in FIG. 38 are performed in steps S266 and S267. Thereafter, the foregoing processes are repeated until it is determined that all the station information in the selectable list has been selected as noted station information. When it is determined in step S266 that all the station information in the selectable list has been selected as noted station information, the selectable list registering process in FIG. 39 ends. Then, the process returns.

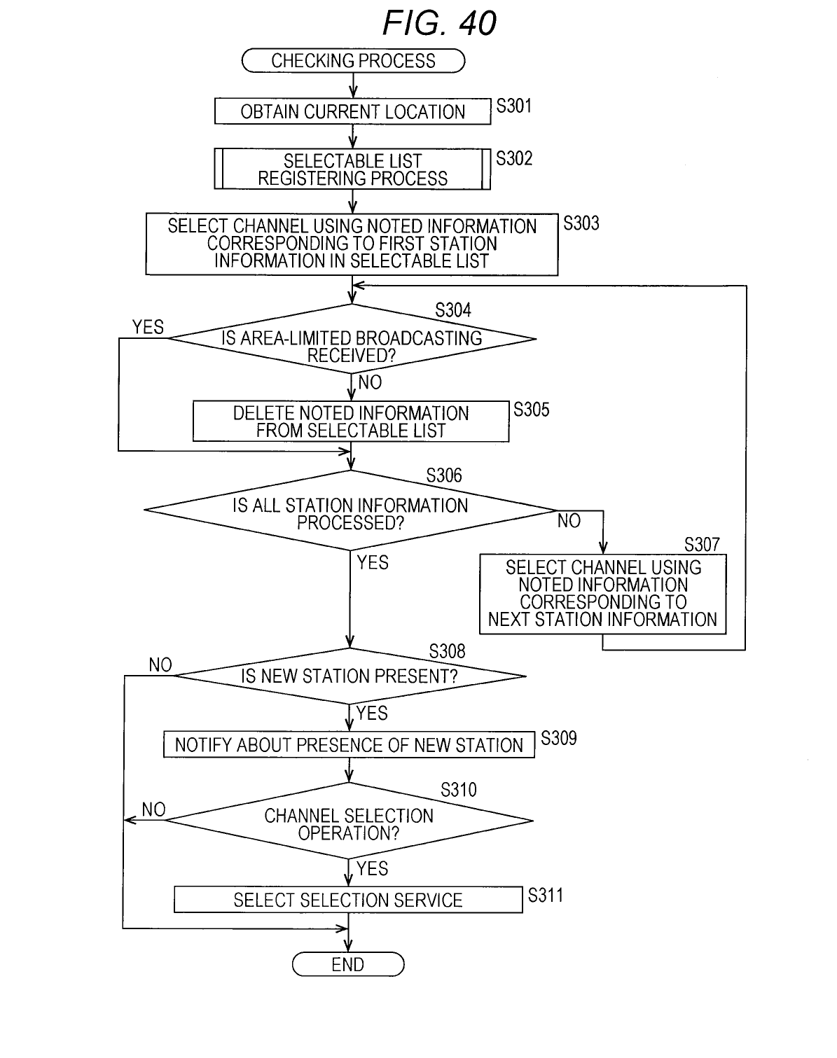

FIG. 40 is a flowchart describing a checking process performed by the receiving terminal 33 in FIG. 22.

There is a case when the current location is contained in a broadcasting area of a new station when the current location changes by a shift of the user carrying the receiving terminal 33 after completion of the selecting process in the GPS mode in FIG. 36.

In the checking process, it is checked whether or not the current location after a change of the current location is contained in a broadcasting area of a new station. When the current location after the change is contained in the broadcasting area of the new station and allows the receiving terminal 33 to receive the area-limited broadcasting provided by the new station, the presence of the new station is notified to the user.

More specifically, in the checking process, the station selecting unit 117 obtains the current location (of the receiving terminal 33), and supplies the current location to the channel selection control unit 118 in step S301. Then, the process proceeds to step S302.

In step S302, the station selecting unit 117 selects station information corresponding to the station providing area-limited broadcasting and expected to be receivable at the current location from station information registered in the station list of the storing unit 115 similarly to step S204 in FIG. 36, and performs the selectable list registering process for registering the selected station information in the selectable list.

The details of the selectable list registering process are similar to those described in FIGS. 38 and 39.

Then, the station selecting unit 117 supplies the selectable list registering station information of selectable stations and obtained by the selectable list registering process to the channel selection control unit 118.

Then, the process proceeds from step S302 to step S303. Thereafter, the same processes as in steps S135 through S139 in FIG. 30 are performed in steps S303 through S307 to perform reception check.

After the reception check is completed in steps S303 through S307, in step S308, the channel selection control unit 118 determines whether or not reception of area-limited broadcasting provided by the selectable stations (hereinafter referred to as new selectable stations) from which reception of area-limited broadcasting has not been confirmed in the previous reception check (processes in steps S303 through S307 performed immediately before the current reception check, or processes in steps S206 through S210 in the selecting process in the GPS mode in FIG. 36) has been newly confirmed in the current reception check (processes in steps S303 through S307 performed just completed).

When it is determined in step S308 that the reception of the area-limited broadcasting provided by the new selectable stations has not been newly confirmed by the current reception check, the process skips steps S309 through S311. Then, the checking process ends.

On the other hand, when it is determined in step S308 that the reception of the area-limited broadcasting provided by the new selectable stations has been newly confirmed by the current reception check, i.e., when station information about a new selectable station not registered in the selectable list supplied from the station selecting unit 117 to the channel selection control unit 118 in the previous reception check is registered in the selectable list supplied from the station selecting unit 117 to the channel selection control unit 118 in the current reception check, the process proceeds to step S309. In this step, the channel selection control unit 118 notifies the presence of the new selectable station.

In this case, the channel selection control unit 118 notifies the user of the presence of the new selectable station by displaying, on the display unit 76, a notifying screen for notifying the presence of the new selectable station, or outputting voices for notifying the presence of the new selectable station from the speaker 78, for example.

Thereafter, the process proceeds from step S309 to step S310. In this step, the channel selection control unit 118 determines whether or not the user has carried out channel selection operation for selecting the new selectable station, and for selecting a service area-limited-broadcasted by the new selectable station. When it is determined that this operation has not been carried out, the process skips step S311, and ends the checking process.

When it is determined in step S310 that the channel selection operation has been carried out, i.e., when the new selectable station has been selected as a selection station, the process proceeds to step S311. In this step, the channel selection control unit 118 performs channel selection control for allowing the tuner 72 to select the selection service. Then, the checking process ends.

The checking process is repeated periodically, for example.

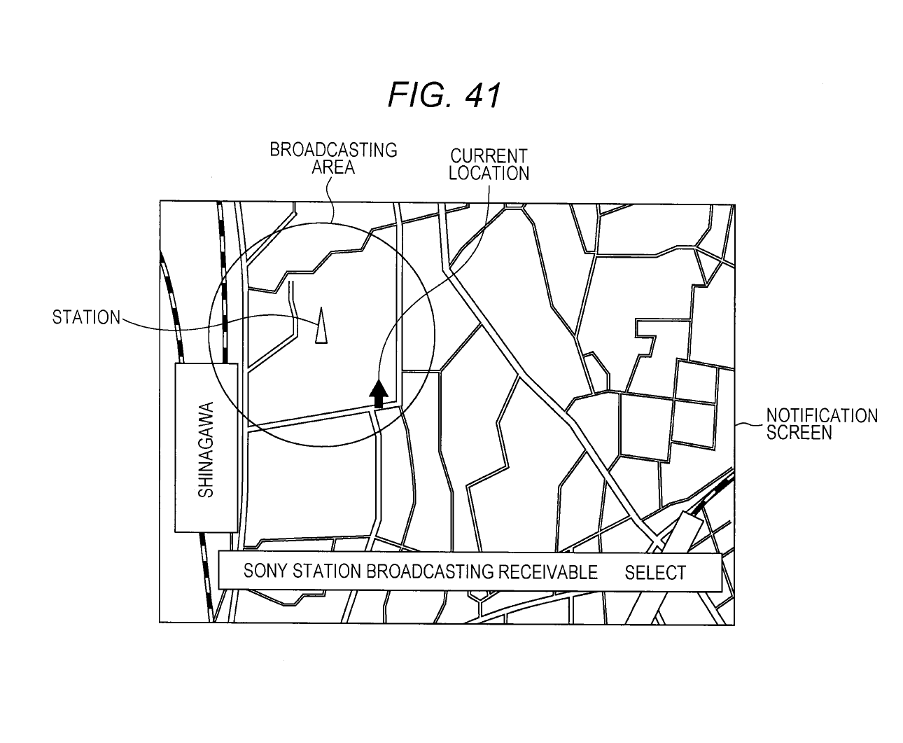

FIG. 41 is a figure illustrating an example of the notifying screen.

The notifying screen in FIG. 41 displays a map containing the current location, and further a mark (triangular mark) representing a new selectable station at the position of the corresponding selectable station on the map.

In addition, the notifying screen in FIG. 41 displays a mark (mark in an arrow shape) representing the current location, a circle representing the broadcasting area of the new selectable station, and a message notifying that a service provided by the new selectable station is receivable on the map.

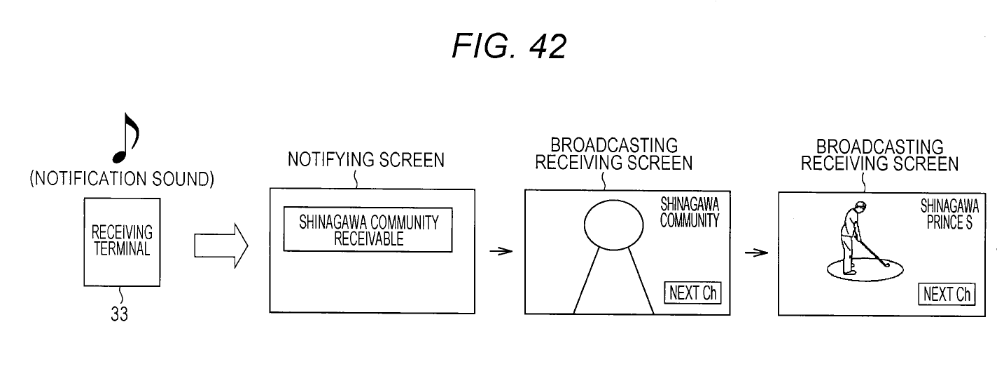

FIG. 42 is a figure illustrating a display example of the display unit 76 when the receiving terminal 33 in FIG. 22 performs the checking process in FIG. 40.

When reception of area-limited broadcasting by a new selectable station is newly confirmed by current reception check in the checking process, the channel selection control unit 118 outputs notification sound for notifying the presence of the new selectable station from the speaker 78, and further displays a notifying screen on the display unit 76, for example, so as to notify the presence of the new selectable station to the user.

When the user subsequently selects the service area-limited-broadcasted by the new selectable station as a selection service by carrying out channel selection operation, the tuner 72 receives the selection service. As a result, a broadcasting receiving screen displaying an image of the selection service is displayed on the display unit 76.

When a plurality of new selectable stations provide area-limited broadcasting, a “next ch” button is also displayed on the broadcasting receiving screen.

When the user operates the “next ch” button, a service area-limited-broadcasted by another new selectable station is selected as a new selection service. Then, the new selection service is selected.

Thereafter, a broadcasting receiving screen displaying an image of the selection service obtained by the channel selection is displayed on the display unit 76.

When the presence of a new selectable station is notified to the user in the checking process performed periodically as above, the user can recognize the presence of the new selectable station at a position after a shift without carrying out the channel selecting process in the GPS mode for every shift of the user.

### [Description of Computer Incorporating Present Technology]

A series of the foregoing processes performed by the stations 32 and the receiving terminal 33 may be implemented by hardware, or may be implemented by software. When the series of the processes are implemented by software, a program constituting the software is installed in a computer. Examples of the computer in this context include a computer incorporated in dedicated hardware, and a computer capable of performing various types of functions under various types of programs installed in the computer, such as a general-purpose computer, for example.

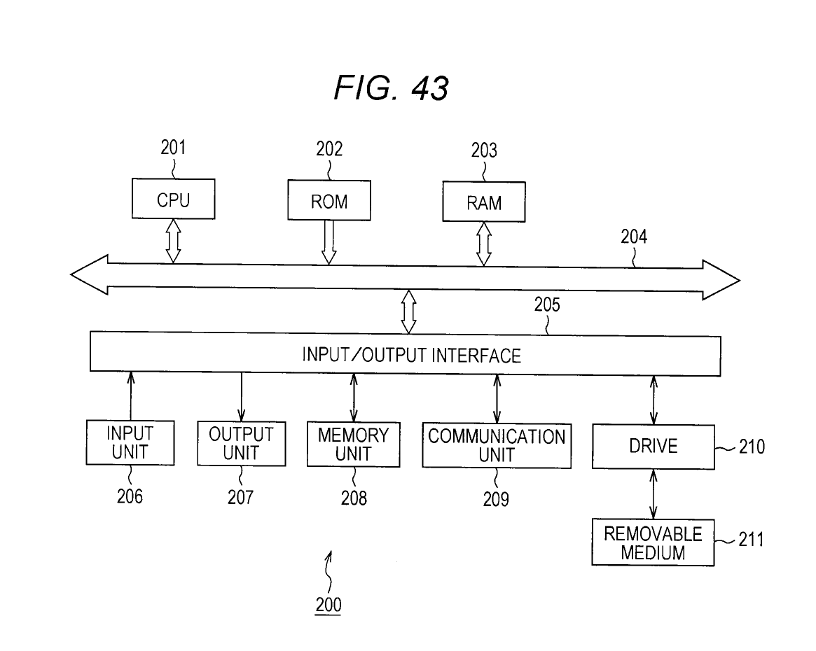

FIG. 43 is a block diagram showing a constitution example of hardware of a computer implementing a series of the foregoing processes under a program.

According to a personal computer 200, a CPU (Central Processing Unit) 201, a ROM (Read Only Memory) 202, and a RAM (Random Access Memory) 203 are connected with one another via a bus 204.

An input/output interface 205 is further connected with the bus 204. An input unit 206, an output unit 207, a memory unit 208, a communication unit 209, and a drive 210 are connected with the input/output interface 205.

The input unit 206 is constituted by a keyboard, a mouse, a microphone and others. The output unit 207 is constituted by a display, a speaker and others. The memory unit 208 is constituted by a hard disk, a non-volatile memory and others. The communication unit 209 is constituted by a network interface and others. The drive 210 drives a removable medium 211 such as a magnetic disk, an optical disk, a magneto-optical disk, and a semiconductor memory.

According to the personal computer 200 thus constructed, the CPU 201 loads a program stored in the memory unit 208 into the RAM 203 via the input/output interface 205 and the bus 204, and implements the program to perform the series of the foregoing processes, for example.

The program implemented by the personal computer 200 (CPU 201) may be recorded on the removable medium 211 and provided in the form of a package medium, for example. In addition, the program may be provided via a wired or wireless transmission medium such as a local area network, the Internet, and digital satellite broadcasting.

According to the personal computer 200, the program may be installed into the memory unit 208 via the input/output interface 205 by attachment of the removable medium 211 to the drive 210. Alternatively, the program may be received by the communication unit 209 via a wired or wireless transmission medium, and installed into the memory unit 208. Instead, the program may be installed in the ROM 202 or the memory unit 208 beforehand.

The program implemented by the computer may be a program under which the processes are performed in time series in the order discussed in this specification, or may be a program under which the processes are performed in parallel or at necessary timing such as calls.

Moreover, embodiments of the present technology are not limited to the embodiment described herein. Various changes may be made without departing from the scope of the present technology.

Furthermore, the present technology may have the following configurations.

[1]

A receiver including:

an obtaining unit obtaining service area information used for selecting a service of broadcasting provided by a station which is included in stations transmitting broadcasting waves of the broadcasting at an arbitrary segment and transmits broadcasting waves receivable at a predetermined position;

a storing unit storing the service area information;

a selecting unit selecting a station transmitting broadcasting waves receivable at a predetermined position as a selectable station which is selectable based on the service area information; and

a channel selection control unit performing channel selection control for selecting the service of the broadcasting provided by the selectable station.

[2]

The receiver according to [1], wherein

the service area information is information used for calculating reception sensitivity, and

the selecting unit selects a selectable station from stations transmitting broadcasting waves in accordance with the reception sensitivity calculated based on the service area information.

[3]

The receiver according to [2], wherein

the service area information contains position information of the stations, transmission output information concerning transmission output of broadcasting waves from the stations, and directivity information concerning directivity of broadcasting waves from the stations,

the selecting unit obtains position information indicating a current position of the receiver, and

the selecting unit selects a station as a selectable station when the reception sensitivity of the station calculated based on the position information of the receiver, the position information of the station, the transmission output information, and the directivity information exceeds a predetermined threshold.

[4]

The receiver according to [3], wherein the directivity information includes coefficients calculated based on directivity patterns corresponding to the stations.

[5]

The receiver according to [3] or [4], wherein the position information of the stations includes information indicating the longitudes, latitudes, and heights of the locations of the stations.

[6]

The receiver according to [1], wherein

the service area information is information used for calculating receivable distances corresponding to ranges where broadcasting waves from the stations are receivable, and

the selecting unit selects a selectable station from stations transmitting broadcasting waves in accordance with the receivable distances calculated based on the service area information.

[7]

The receiver according to [6], wherein

the service area information contains the position information of the stations, directivity information concerning directivity of broadcasting waves from the stations, and estimated receivable distances estimated beforehand and indicating ranges where broadcasting waves from the stations are receivable, and

the selecting unit obtains position information indicating a current position of the receiver, and

the selecting unit selects a station as a selectable station when the receivable distance of the station calculated based on the directivity information and the estimated receivable distance exceeds a distance between a current position of the receiver and the station calculated based on the position information of the receiver and the position information of the station.

[8]

The receiver according to [7], wherein the directivity information includes coefficients calculated based on directivity patterns corresponding to the stations.

[9]

The receiver according to [7] or [8], wherein the position information of the stations includes information indicating the longitudes, latitudes, and heights of the locations of the stations.

[10]

The receiver according to any of [1] to [9], wherein the selecting unit selects a station transmitting the broadcasting receivable in an area selected by a user as a selectable station based on the service area information.

[11]

The receiver according to any of [1] to [10], wherein

the channel selection control unit allows display of information about the selectable station, and

the channel selection control unit allows selection of a service of the broadcasting provided by the station selected by the user based on the display of the information about the selectable station.

[12]

The receiver according to any of [1] to [11], wherein

the channel selection control unit performs reception check for checking whether or not the broadcasting provided by the selectable station is receivable, and

the channel selection control unit allows display of information about only the selectable station the reception of the broadcasting of which has been confirmed.

[13]

The receiver according to any of [1] to [12], wherein the broadcasting is one segment broadcasting.

[14]

A receiving method, including steps performed by a receiver and including:

obtaining service area information used for selecting a service of broadcasting provided by a station which is included in stations transmitting broadcasting waves of the broadcasting at an arbitrary segment and transmits broadcasting waves receivable at a predetermined position;

storing the service area information;

selecting a station transmitting broadcasting waves receivable at a predetermined position as a selectable station which is selectable based on the service area information; and

performing channel selection control for selecting the service of the broadcasting provided by the selectable station.

[15]

A program for a computer having the functions of:

an obtaining unit obtaining service area information used for selecting a service of broadcasting provided by a station which is included in stations transmitting broadcasting waves of the broadcasting at an arbitrary segment and transmits broadcasting waves receivable at a predetermined position;

a storing unit storing the service area information;

a selecting unit selecting a station transmitting broadcasting waves receivable at a predetermined position as a selectable station which is selectable based on the service area information; and

a channel selection control unit performing channel selection control for selecting the service of the broadcasting provided by the selectable station.

### REFERENCE SIGNS LIST

31 Terrestrial broadcasting station
32-1 through 32-3 Station
33 Receiving terminal
51 Associated information obtaining unit
52 Video data obtaining unit
53 Video encoder
54 Audio data obtaining unit
55 Audio encoder
56 Multiplexer
57 Transmitting unit
58, 71 Antenna
72 Tuner
73 Demultiplexer
74 Video decoder
75 Selection unit
76 Display unit
77 Audio decoder
78 Speaker
79 Browser
80 Control unit
81 Operation unit
82 Wireless communication I/F
111 through 113 Station information obtaining unit
114 Registering unit
115 Storing unit
116 Updating unit
117 Station selecting unit
118 Channel selection control unit
201 CPU
202 ROM
203 RAM
204 Bus
205 Input/output interface
206 Input unit
207 Output unit
208 Memory unit
209 Communication unit
210 Drive
211 Removable medium

1. A receiver comprising:
an obtaining unit obtaining service area information used for selecting a service of broadcasting provided by a station which is included in stations transmitting broadcasting waves of the broadcasting at an arbitrary segment and transmits broadcasting waves receivable at a predetermined position;
a storing unit storing the service area information;
a selecting unit selecting a station transmitting broadcasting waves receivable at a predetermined position as a selectable station which is selectable based on the service area information; and
a channel selection control unit performing channel selection control for selecting the service of the broadcasting provided by the selectable station.

2. The receiver according to claim 1, wherein
the service area information is information used for calculating reception sensitivity, and
the selecting unit selects a selectable station from stations transmitting broadcasting waves in accordance with the reception sensitivity calculated based on the service area information.

3. The receiver according to claim 2, wherein
the service area information contains position information of the stations, transmission output information concerning transmission output of broadcasting waves from the stations, and directivity information concerning directivity of broadcasting waves from the stations,
the selecting unit obtains position information indicating a current position of the receiver, and
the selecting unit selects a station as a selectable station when the reception sensitivity of the station calculated based on the position information of the receiver, the position information of the station, the transmission output information, and the directivity information exceeds a predetermined threshold.

4. The receiver according to claim 3, wherein the directivity information includes coefficients calculated based on directivity patterns corresponding to the stations.

5. The receiver according to claim 3, wherein the position information of the stations includes information indicating the longitudes, latitudes, and heights of the locations of the stations.

6. The receiver according to claim 1, wherein
the service area information is information used for calculating receivable distances corresponding to ranges where broadcasting waves from the stations are receivable, and
the selecting unit selects a selectable station from stations transmitting broadcasting waves in accordance with the receivable distances calculated based on the service area information.

7. The receiver according to claim 6, wherein
the service area information contains the position information of the stations, directivity information concerning directivity of broadcasting waves from the stations, and estimated receivable distances estimated beforehand and indicating ranges where broadcasting waves from the stations are receivable, and
the selecting unit obtains position information indicating a current position of the receiver, and
the selecting unit selects a station as a selectable station when the receivable distance of the station calculated based on the directivity information and the estimated receivable distance exceeds a distance between a current position of the receiver and the station calculated based on the position information of the receiver and the position information of the station.

8. The receiver according to claim 7, wherein the directivity information includes coefficients calculated based on directivity patterns corresponding to the stations.

9. The receiver according to claim 7, wherein the position information of the stations includes information indicating the longitudes, latitudes, and heights of the locations of the stations.

10. The receiver according to claim 1, wherein the selecting unit selects a station transmitting the broadcasting receivable in an area selected by a user as a selectable station based on the service area information.

11. The receiver according to claim 1, wherein
the channel selection control unit allows display of information about the selectable station, and
the channel selection control unit allows selection of a service of the broadcasting provided by the station selected by the user based on the display of the information about the selectable station.

12. The receiver according to claim 1, wherein
the channel selection control unit performs reception check for checking whether or not the broadcasting provided by the selectable station is receivable, and
the channel selection control unit allows display of information about only the selectable station the reception of the broadcasting of which has been confirmed.

13. The receiver according to claim 1, wherein the broadcasting is one segment broadcasting.

14. A receiving method, comprising steps performed by a receiver and including:
obtaining service area information used for selecting a service of broadcasting provided by a station which is included in stations transmitting broadcasting waves of the broadcasting at an arbitrary segment and transmits broadcasting waves receivable at a predetermined position;
storing the service area information;
selecting a station transmitting broadcasting waves receivable at a predetermined position as a selectable station which is selectable based on the service area information; and
performing channel selection control for selecting the service of the broadcasting provided by the selectable station.

15. A program for a computer having the functions of:
an obtaining unit obtaining service area information used for selecting a service of broadcasting provided by a station which is included in stations transmitting broadcasting waves of the broadcasting at an arbitrary segment and transmits broadcasting waves receivable at a predetermined position;
a storing unit storing the service area information;
a selecting unit selecting a station transmitting broadcasting waves receivable at a predetermined position as a selectable station which is selectable based on the service area information; and
a channel selection control unit performing channel selection control for selecting the service of the broadcasting provided by the selectable station.
